(19) United States
(12) Patent Application Publication
(10) Pub. No.: US 2026/0116241 A1
(43) Pub. Date: Apr. 30, 2026

(54) Method for Constructing Optimal Scheduling Model of Integrated Energy System Considering Virtual Thermal Storage

(71) Applicant: Guizhou Power Grid Co., Ltd., Guiyang (CN)

(72) Inventors: Qingsheng LI, Guiyang (CN); Jierui YANG, Guiyang (CN); Zhaofeng ZHANG, Guiyang (CN); Zhen LI, Guiyang (CN); Bin WANG, Guiyang (CN); Yinjun LIU, Guiyang (CN); Chengeng NIU, Guiyang (CN); Changming CHEN, Guiyang (CN); Zhenzhi LIN, Guiyang (CN); Li YANG, Guiyang (CN); Tianxuan ZHONG, Guiyang (CN); Kuanxiang ZHAO, Guiyang (CN); Zhibang WANG, Guiyang (CN); Wei WANG, Guiyang (CN); Yongqing ZHU, Guiyang (CN); Chen LUO, Guiyang (CN)

(21) Appl. No.: 19/076,162

(22) Filed: Mar. 11, 2025

Related U.S. Application Data
(63) Continuation of application No. PCT/CN2024/140006, filed on Dec. 17, 2024.

(30) Foreign Application Priority Data
Oct. 25, 2024 (CN) 2024115034127

(51) Int. Cl. B60L 53/64; B60L 53/10; B60L 53/51; B60L 53/52; B60L 53/57; G06Q 50/06; H02J 3/32; H02J 3/46

(52) U.S. Cl. CPC B60L 53/64; B60L 53/11; B60L 53/51; B60L 53/52; B60L 53/57; G06Q 50/06; H02J 3/32; H02J 3/466; H02J 2101/24; H02J 2101/28; H02J 2103/30

(57) ABSTRACT

Disclosed is a method for constructing an optimal scheduling model of an integrated energy system considering virtual thermal storage, which relates to the technical field of electric power systems. The method includes: establishing an operation model of an apparatus, a demand response model of an energy load, a charging model of an electric vehicle, and an energy flow model of a heat supply network of the virtual thermal storage in the integrated energy system; processing, according to a second-order cone relaxation method, a direct current power flow model of a power distribution network, and constructing the optimal scheduling model of the integrated energy system by taking minimization of total cost of an energy operator as an objective, thereby coordinately and optimally scheduling a plurality of energy sources.

### CROSS-REFERENCE TO RELATED APPLICATIONS

The present application is a continuation of International Application No. PCT/CN2024/140006, filed on Dec. 17, 2024, which claims priority to Chinese Patent Application No. 2024115034127, filed on Oct. 25, 2024, the entire disclosure of which is incorporated herein by reference.

### TECHNICAL FIELD

The disclosure relates to the technical field of electric power systems, and in particular to a method for constructing an optimal scheduling model of an integrated energy system considering virtual thermal storage.

### BACKGROUND

Owing to current shortage of fossil fuels and increasingly severe environmental pollution, a potential threat has been posed to sustainable development, and contradiction between supply and demand of energy is growing prominent. As a result, it is not only necessary to transform an electric power system, but also necessary to develop a low-carbon, safe and efficient modern energy system, so as to improve energy utilization efficiency. By means of multi-energy complementary characteristics, an integrated energy system can effectively improve economic efficiency, environmental friendliness and reliability of the system to some extent, save integrated cost of an operator, and contribute to the sustainable development of human society. So, it is of great significance to study an operational optimization strategy of the urban integrated energy system under the background of dual-carbon target.

Given that a variety of types of energy in the urban integrated energy system can be converted into each other, the synergistic effect of a variety of types of resources will inevitably have a large amount of adjustable space under a determined objective function, which manifests flexibility of the resources of the integrated energy system. An optimal scheduling strategy can be obtained by means of solution, thereby better coordinating a variety of flexible resources to determine an output or an adjustment amount of different resources at different moments, making full use of a variety of types of flexible resources, and simultaneously saving cost and improving economic benefits. Decision-making is crucially tied to complexity of an energy conversion structure, differences in a variety of energy time scales, energy flow differences, and uncertainties from source and load sides, which need to be considered in a process. So, it is necessary to carry out research on optimal scheduling of the integrated energy system in order to obtain an optimal scheduling solution for the urban integrated energy system.

### SUMMARY

In view of the above problem, the disclosure is provided.

Thus, the technical problem to be solved by the disclosure is how to achieve low-carbon, safe and efficient energy transformation in the context of shortage of fossil fuels and increasingly severe environmental pollution.

In order to solve the above technical problem, the disclosure provides the following technical solution: a method for constructing an optimal scheduling model of an integrated energy system considering virtual thermal storage includes: establishing an operation model of a working apparatus of the integrated energy system, establishing an integrated demand response model of an integrated energy load and an orderly charging model of an electric vehicle (EV), and establishing an energy flow calculation model of a heat supply network considering the virtual thermal storage; processing, based on a mathematical theory, a direct current power flow model of a power distribution network, and transforming a general power flow constraint into a mixed integer quadratic constraint programming constraint according to a second-order cone relaxation method; and constructing, according to power flow constraints of the power distribution network, the heat supply network and a gas network of the integrated energy system, the optimal scheduling model of the integrated energy system considering the virtual thermal storage by taking minimization of total operation cost of an integrated energy operator as an objective function.

As a preferred solution of the method for constructing an optimal scheduling model of an integrated energy system considering virtual thermal storage of the disclosure, the operation model of the working apparatus of the integrated energy system includes a wind turbine model, a photovoltaic generator set model, a combined heat and power unit model, a gas boiler (GB) model, an electric heater (EH) model, a power to gas (P2G) apparatus model, an energy storage system model, and a thermal storage system model.

The wind turbine model is represented by the following formulas:

$$P = \frac{1}{2} ρ {Sv}^{3} ;$$

$${η}_{max} \frac{{P}_{max}}{P} = 0.593 ;$$

$$P = \frac{1}{2} {η}_{w} ρ {Sv}^{3} ;$$

$${P}_{WTG} ( v ) = \{ \begin{matrix}0 ( v \leq {v}_{ci} , v \geq {v}_{co} ) \\ \frac{{v}^{3} - {v}_{ci}^{3}}{{v}_{r}^{3} - {v}_{ci}^{3}} {P}_{r} ( {v}_{ci} \leq v \leq {v}_{r} ) \\ {P}_{r} ( {v}_{r} \leq v \leq {v}_{co} )\end{matrix} ;$$

$${P}_{WTGtotal}^{t} = {P}_{WTG}^{t} + {P}_{WTGwaste}^{t} ; and$$

$$\vert {P}_{WTG}^{t} - {P}_{WTG}^{t - 1} \vert \leq {P}_{WTG , climb} ,$$

where

v is a wind speed of a wind turbine, represents a swept area, and ρ is an air density; ηₘₐₓ is a maximum utilization rate of wind energy, Pₘₐₓ and is maximum output power; η_{w} is utilization rate of the wind energy; Pᵣ and P_{WTG}(v) are rated power and actual power of the wind turbine respectively, v and vᵣ are an actual wind speed and a rated wind speed of the wind turbine respectively, and v_{ci} and v_{co} are an inflow wind speed and an outflow wind speed of the wind turbine respectively;

$${P}_{PVtotal}^{t}$$

is total output power,

$${P}_{PV}^{t}$$

is actual output power, and

$${P}_{PVwaste}^{t}$$

is light rejection power; and P_{WTG,climb} is an upper limit of a climbing constraint.

The photovoltaic generator set model is represented by the following formulas:

$${P}_{PVtotal}^{t} = {P}_{PV}^{t} + {P}_{PVwaste}^{t} ; and \vert {P}_{PV}^{t} - {P}_{PV}^{t - 1} \vert \leq {P}_{PV , climb} ,$$

where

$${P}_{PVtotal}^{t}$$

is total output power of a photovoltaic,

$${P}_{PV}^{t}$$

is actual output power, and

$${P}_{PVwaste}^{t}$$

is light rejection power; and P_{PV,climb} is an upper limit of a climbing constraint of the photovoltaic.

The combined heat and power unit model is represented by the following formulas:

$${P}_{CHP}^{t} = {η}_{CHP}^{E - H} {H}_{CHP}^{t} = {η}_{CHP}^{E - H} ( {η}_{CHP}^{H - G} {G}_{CHP}^{t} ) ;$$

$${P}_{CHP , min} \leq {P}_{CHP}^{t} \leq {P}_{CHP , max} ;$$

$$\vert {P}_{CHP}^{t} - {P}_{CHP}^{t - 1} \vert \leq {P}_{CHP}^{climb , max} ; and$$

$${H}_{CHP}^{t} = {H}_{CHP - TSS}^{t} + {H}_{CHP - Load}^{t} ,$$

where

$${P}_{CHP}^{t}$$

is electric power generated by a combined heat and power unit,

$${H}_{CHP}^{t}$$

is thermal power generated by the combined heat and power unit,

$${G}_{CHP}^{t}$$

is gas power consumed by the combined heat and power unit,

$${η}_{CHP}^{E - H}$$

is an electricity-heat proportion coefficient, and

$${η}_{CHP}^{H - G}$$

is a gas-heat conversion coefficient; P_{CHP,min} and P_{CHP,max} represent a lower limit and an upper limit of an output of the electric power of the combined heat and power unit respectively;

$${P}_{CHP}^{climb , max}$$

represents an upper limit of a climbing rate of the electric power of the combined heat and power unit; and

$${H}_{CHP}^{t}$$

is total heat output power of the combined heat and power unit,

$${H}_{CHP - Load}^{t}$$

is power at which a thermal load is supplied, and

$${H}_{CHP - TSS}^{t}$$

is power at which the thermal load is stored into a thermal storage system.

The GB model is represented by the following formulas:

$${H}_{GB}^{t} = {η}_{GB} {G}_{GB}^{t} , and {H}_{GB , min} \leq {H}_{GB}^{t} \leq {H}_{GB , max} ,$$

where

$${H}_{GB}^{t}$$

is thermal power generated by a GB,

$${G}_{GB}^{t}$$

is gas power consumed by the GB, and η_{GB} is a gas-heat conversion coefficient of the GB; and H_{GB,min} and H_{GB,max} represent a lower limit and an upper limit of an output of the thermal power of the GB.

The EH model is represented by the following formulas:

$${H}_{EH}^{t} = {η}_{EH} {P}_{EH}^{t} , and {P}_{EH , min} \leq {P}_{EH}^{t} \leq {P}_{EH , max} ,$$

where

$${H}_{EH}^{t}$$

is thermal power generated by an EH,

$${P}_{EH}^{t}$$

is electric power consumed by the EH, and η_{EH} is an electricity-heat conversion coefficient of the EH; and P_{EH,min} and P_{EH,max} represent a lower limit and an upper limit of the electric power consumed by the EH respectively.

The P2G apparatus model is represented by the following formulas:

$${G}_{P 2 G}^{t} = {η}_{P 2 G} {P}_{P 2 G}^{t} , and {P}_{P 2 G , min} \leq {P}_{P 2 G}^{t} \leq {P}_{P 2 G , max} ,$$

where

$${G}_{P 2 G}^{t}$$

is gas power generated by P2G,

$${P}_{P 2 G}^{t}$$

is electric power consumed by the P2G, and η_{P2G} is an electricity-gas conversion coefficient of the EH; and P_{P2G,min} and P_{P2G,max} represent a lower limit and an upper limit of the electric power consumed by the P2G respectively.

The energy storage system model is represented by the following formulas:

$${C}_{SOC}^{t} = ( 1 - γ ) {C}_{SOC}^{t - 1} + λ {P}_{c}^{t} Δ t - \frac{{P}_{dis}^{t}}{λ} Δ t ;$$

$${P}_{c}^{t} {P}_{dis}^{t} = 0 ;$$

$${C}_{SOC}^{0} = {C}_{SOC}^{T} ;$$

$${C}_{SOC , min} \leq {C}_{SOC}^{t} \leq {C}_{SOC , max} ;$$

$${P}_{c}^{t} \leq {P}_{c , max} ; and$$

$${P}_{dis}^{t} \leq {P}_{dis , max} ,$$

where

$${C}_{SOC}^{t} and {C}_{SOC}^{t - 1}$$

represent states of charges (SOCs) of a battery at a moment t and a moment t−1 respectively,

$${P}_{c}^{t} and {P}_{dis}^{t}$$

represent charge power and discharge power at the moment t respectively, γ is an electric energy dissipation coefficient of the energy storage system, λ is a charge and discharge efficiency coefficient of the battery, and Δt is unit scheduling time; and T represents a scheduling period,

$${C}_{SOC}^{0} and {C}_{SOC}^{T}$$

represent SOCs of the energy storage system at a beginning and an end of the scheduling period respectively, c_{SOC,min} and C_{SOC,max} represent a lower limit and an upper limit of the SOC of the energy storage system, P_{c,max} is an upper limit of the charge power of the energy storage system, and P_{dis,max} is an upper limit of the discharge power of the energy storage system.

The thermal storage system model is represented by the following formulas:

$${C}_{TSS}^{t} = ( 1 - β ) {C}_{TSS}^{t - 1} + {H}_{c}^{t} Δ t - {H}_{dis}^{t} Δ t ;$$

$${H}_{c}^{t} {H}_{dis}^{t} = 0 ;$$

$${C}_{TSS}^{0} = {C}_{TSS}^{T} ;$$

$${C}_{TSS , min} \leq {C}_{TSS}^{t} \leq {C}_{TSS , max} ;$$

$${H}_{c}^{t} \leq {H}_{c , max} ; and$$

$${H}_{dis}^{t} \leq {H}_{dis , max} ,$$

where

$${C}_{TSS}^{t} and {C}_{TSS}^{t - 1}$$

represent thermal storage amounts of the thermal storage system at the moment t and the moment t−1 respectively,

$${H}_{c}^{t} and {H}_{dis}^{t}$$

represent thermal storage power and thermal release power of the thermal storage system at the moment t respectively, and β is a dissipation coefficient of the thermal storage system; and

$${C}_{TSS}^{0} and {C}_{TSS}^{T}$$

represent thermal storage amounts of the thermal storage system at the beginning and the end of the scheduling period respectively, c_{TSS,min} and c_{TSS,max} represent a lower limit and an upper limit of the thermal storage amount of the thermal storage system, H_{c,max} is an upper limit of the thermal storage power of the thermal storage system, and H_{dis,max} is an upper limit of the thermal release power of the thermal storage system.

As a preferred solution of the method for constructing an optimal scheduling model of an integrated energy system considering virtual thermal storage of the disclosure, the integrated demand response model of the integrated energy load is represented by the following formulas:

$${P}_{IDR}^{t} = {P}_{IDR}^{t , int} + {P}_{IDR}^{t , shi} + {P}_{IDR}^{t , cha} ;$$

$$0 \leq {P}_{IDR}^{t , int} \leq {γ}_{IDR}^{t , int} {P}_{L}^{t} ;$$

$${P}_{IDR}^{t , shi} = {P}_{IDRout}^{t , shi} - {P}_{IDRin}^{t , shi} ;$$

$${P}_{IDRout}^{t , shi} {P}_{IDRin}^{t , shi} = 0 ;$$

$${\sum }_{t = 1}^{T} {P}_{IDRout}^{t , shi} = {\sum }_{t = 1}^{T} {P}_{IDRin}^{t , shi} ;$$

$$0 \leq {P}_{IDR}^{t , shi} \leq {P}_{IDR}^{shi , max} ;$$

$$0 \leq {P}_{IDR}^{t , cha} \leq {γ}_{IDR}^{cha} {P}_{L}^{t} ;$$

$${P}_{L}^{t , actual} = {P}_{L}^{t} - {P}_{IDR}^{t , int} - {P}_{IDR}^{t , shi} - {P}_{IDR}^{t , cha} ;$$

$${H}_{IDR}^{t , cha} = {η}_{IDR}^{E - H} {P}_{IDR}^{t , cha} ;$$

$${G}_{IDR}^{t , cha} = {η}_{IDR}^{E - G} {P}_{IDR}^{t , cha} ;$$

$${H}_{L}^{t , actual} = {H}_{L}^{t} - {H}_{IDR}^{t , int} - {H}_{IDR}^{t , shi} + {H}_{IDR}^{t , cha} ;$$

$${G}_{L}^{t , actual} = {G}_{L}^{t} - {G}_{IDR}^{t , int} - {G}_{IDR}^{t , shi} + {G}_{IDR}^{t , cha} ; and$$

$${η}_{IDR}^{E - H} + {η}_{IDR}^{E - G} \leq 1 ,$$

where

$${P}_{IDR}^{t , int} , {P}_{IDR}^{t , shi} and {P}_{IDR}^{t , cha}$$

and represent a reducible load, a transferable load and a substitutional load respectively;

$${γ}_{IDR}^{int}$$

is a maximum participation proportion coefficient of the reducible load, and

$${P}_{L}^{t}$$

is a total electric load at the moment t;

$${P}_{IDR}^{shi , max}$$

is a maximum participation value of the transferable load;

$${γ}_{IDR}^{cha}$$

is a maximum participation proportion coefficient of the substitutional load;

$${H}_{IDR}^{t , cha}$$

is thermal load power converted from the substitutional load, and

$${η}_{IDR}^{E - H}$$

is an electricity-heat conversion coefficient of the substitutional load; and

$${G}_{IDR}^{t , cha}$$

is gas load power converted from the substitutional load, and

$${η}_{IDR}^{E - G}$$

is an electricity-gas conversion coefficient; and
the orderly charging model of the EV is represented by the following formulas:

$$( {C}_{EVSOC}^{out , k} - {C}_{EVSOC}^{in , k} ) {E}_{k} \leq {W}_{EV}^{k} \leq ( 1 - {C}_{EVSOC}^{in , k} ) {E}_{k} ;$$

$$( {C}_{EVSOC}^{t , k} - {C}_{EVSOC}^{t - 1 , k} ) {E}_{k} = {α}_{k , t} {p}_{k , t} Δ t ;$$

$${W}_{EV}^{k} = {\sum }_{t = 1}^{{T}_{k}} {α}_{k , t} {p}_{k , t} Δ t ; and$$

$${P}_{EV}^{t} = {\sum }_{k = 1}^{{N}_{EV}} {α}_{k , t} {p}_{k , t} Δ t ,$$

where

k is a number of the EV,

$${C}_{EVSOC}^{out , k}$$

represents a percentage of a minimum off-grid SOC specified by an EV user having the number of k in battery capacity,

$${C}_{EVSOC}^{in , k}$$

represents a percentage of an on-grid SOC of the EV in the battery capacity, Eₖ is the battery capacity, and

$${W}_{EV}^{k}$$

is a total charge demand of the user;

$${C}_{EVSOC}^{t , k} and {C}_{EVSOC}^{t - 1 , k}$$

are SOCs of the vehicle k in a period of time t and a period of time t−1 respectively; p_{k,t} is average charge and discharge power of the EV in a fast charge mode; α_{k,t} is a 01 variable representing charging or occupation, i.e. an identifier, is valued as 0 or 1, and represents that the vehicle is in an occupied state and a charge state respectively; Tₖ represents the total number of periods of time during which the vehicle k is accessed to a power grid; and N_{EV} represents the number of EVs.

As a preferred solution of the method for constructing an optimal scheduling model of an integrated energy system considering virtual thermal storage of the disclosure, the energy flow calculation model of the heat supply network considering the virtual thermal storage includes:
a power exchange model of an initial heat exchange station and a heat exchange station being as follows:

$$( {H}_{CHP}^{t} + {H}_{EH - Load}^{t} + {H}_{dis}^{t} + {H}_{GB}^{t} ) Δ t = {c}_{w} {m}_{HS}^{t} ( {T}_{HS , in}^{t , S} - {T}_{HS , out}^{t , R} ) , and$$

$${c}_{w} {m}_{HES}^{t} ( {T}_{HESout}^{t , S} - {T}_{HESin}^{t , R} ) = {H}_{L}^{t} Δ t ,$$

where

$${T}_{HS , in}^{t , S} and {T}_{HS , out}^{t , R}$$

are an inlet temperature in a water supply pipeline and an outlet temperature in a water return pipeline connected to the initial heat exchange station respectively;

$${m}_{HS}^{t}$$

is a flow rate of water flowing through the initial heat exchange station; c_{w} is specific heat capacity of the water;

$${T}_{HESout}^{t , S} and {T}_{HESin}^{t , R}$$

are an outlet temperature in the water supply pipeline and an inlet temperature in the water return pipeline connected to the heat exchange station respectively;

$${m}_{HES}^{t}$$

is a flow rate of hot water flowing through the heat exchange station; and

$${H}_{L}^{t}$$

is a thermal load at the moment t;
a temperature mixing constraint and a range constraint being as follows:

$${\sum }_{j ∈ {Ω}_{h , n}^{pipe -}} {T}_{j , out}^{t} {q}_{j} = {T}_{k , in}^{t} {\sum }_{k ∈ {Ω}_{h , n}^{pipe +}} {q}_{k} ;$$

$${T}_{min}^{S} \leq {T}_{p}^{t , S} \leq {T}_{max}^{S} , ∀ p ∈ {Ω}_{h}^{pipe} ; and$$

$${T}_{min}^{R} \leq {T}_{p}^{t , R} \leq {T}_{max}^{R} , ∀ p ∈ {Ω}_{h}^{pipe} ,$$

where

$${Ω}_{h , n}^{pipe +} and {Ω}_{h , n}^{pipe -}$$

represent pipeline sets starting from and ending at a node n in the heat supply network respectively;

$${T}_{k , in}^{t}$$

is an inlet temperature of a water supply pipeline k at the moment t; qₖ and qⱼ are flow rates of water supply pipelines k and j respectively, which are kept constant;

$${T}_{j , out}^{t}$$

is an outlet temperature of the water supply pipeline j at the moment t;

$${T}_{max}^{S} and {T}_{min}^{S}$$

are an upper limit and a lower limit of a temperature of the water supply pipeline respectively; and

$${T}_{max}^{R} and {T}_{min}^{R}$$

are an upper limit and a lower limit of a temperature of the water return pipeline respectively;
according to a node method, the heat supply network considering transmission delay and temperature loss being modeled as follows:

$${τ}_{p}^{s} = \frac{{l}_{p}^{s} {S}_{p}^{s} {ρ}_{w}}{{q}_{p}^{s} Δ t} ;$$

$$K = ⌈ {τ}_{p}^{s} ⌉ ;$$

$${τ}_{p}^{K - 1 , S} = ( K - 1 ) Δ t ;$$

$${τ}_{p}^{K , S} = K Δ t ;$$

$${T}_{p , out}^{t , K , S} = {e}^{- {k}_{p}^{S} {l}_{p}^{S} / {q}_{p}^{S} {c}_{w}} ( {T}_{p , in}^{t - ( K - 1 ) , S} - {T}_{env}^{t} ) + {T}_{env}^{t} ;$$

$${T}_{p , out}^{t , S} = {W}_{1} {W}_{3} {T}_{p , in}^{t - ( K - 1 ) , S} + {W}_{2} {W}_{3} {T}_{p , in}^{t - K , S} + ( 1 - {W}_{1} {W}_{3} - {W}_{2} {W}_{3} ) {T}_{env}^{t} ;$$

$${W}_{1} = \frac{{q}_{p}^{S} ( {τ}_{p}^{K , S} - {τ}_{p}^{S} )}{[ {q}_{p}^{S} ( {τ}_{p}^{K , S} - {τ}_{p}^{S} ) + {q}_{p + 1}^{S} ( {τ}_{p}^{S} - {τ}_{p}^{K - 1 , S} ) ]} ;$$

$${W}_{2} = \frac{{q}_{p + 1}^{S} ( {τ}_{p}^{S} - {τ}_{p}^{K - 1 , S} )}{[ {q}_{p}^{S} ( {τ}_{p}^{K , S} - {τ}_{p}^{S} ) + {q}_{p + 1}^{S} ( {τ}_{p}^{S} - {τ}_{p}^{K - 1 , S} ) ]} ; and$$

$${W}_{3} = {e}^{- {k}_{p}^{S} {l}_{p}^{S} / {q}_{p}^{S} {c}_{w}} ,$$

where
a superscript S only represents the water supply pipeline, a subscript p only represents a pipeline p, and a physical meaning of each symbol is kept consistent with that of the above;

$${τ}_{p}^{s}$$

is a transmission delay time constant of a whole pipeline, and

$${l}_{p}^{S} and {S}_{p}^{S}$$

represent a length and a cross-sectional area of the water supply pipeline p respectively; ρ_{w} is a density of water;

$${T}_{p , in}^{t - ( K - 1 ) , S}$$

is an inlet temperature of hot water in the water supply pipeline p at a period of time t−(K−1);

$${k}_{p}^{S}$$

is a temperature loss coefficient of the pipeline p; and

$${T}_{env}^{t}$$

is an ambient temperature of a district heat supply network.

As a preferred solution of the method for constructing an optimal scheduling model of an integrated energy system considering virtual thermal storage of the disclosure, the energy flow calculation model of the heat supply network considering the virtual thermal storage further includes:
pipeline energy storage of the heat supply network being as follows:

$${H}_{PES}^{t} = {\sum }_{p , q ∈ {Ω}_{h}^{pipe}} {c}_{w} [ {q}_{p}^{S} ( {T}_{p , out}^{t , S} - {T}_{p , in}^{t , S} ) + {q}_{q}^{R} ( {T}_{q , out}^{t , R} - {T}_{q , in}^{t , R} ) ] Δ t ,$$

where

$${H}_{PES}^{t}$$

represents the pipeline energy storage of the heat supply network; a superscript R only represents the water return pipeline of the heat supply network, and a physical meaning of each symbol is kept consistent with that of the above; and

$${Ω}_{h}^{pipe}$$

is any group of pipeline sets in the heat supply network; and
upper and lower limit constraints and periodic recovery constraints of the pipeline energy storage of the district heat supply network being as follows:

$${H}_{PES , min} \leq {H}_{PES}^{t} \leq {H}_{PES , max} , and$$

$${H}_{PES}^{0} = {H}_{PES}^{T} ,$$

where

H_{PES,max} and P_{ES,min} represent an upper limit and a lower limit of the pipeline energy storage of the heat supply network respectively; and

$${H}_{PES}^{0} are {H}_{PES}^{T}$$

are the pipeline energy storage of the heat supply network at the beginning and the end of the scheduling period respectively.

As a preferred solution of the method for constructing an optimal scheduling model of an integrated energy system considering virtual thermal storage of the disclosure, the direct current power flow model of the power distribution network is processed based on the mathematical theory, and the general power flow constraint is transformed into the mixed integer quadratic constraint programming constraint according to the second-order cone relaxation method:

$${\tilde{U}}_{j}^{t} = {\tilde{U}}_{i}^{t} - 2 {P}_{line , l}^{t} {R}_{line , l} + {I}_{line , l}^{t} {R}_{line , l}^{2} , ∀ l ( i , j ) ∈ {Ω}_{e}^{line} ;$$

$${\sum }_{a ∈ {Ω}_{n}^{+}} {P}_{line , a}^{t} - {\sum }_{b ∈ {Ω}_{n}^{-}} ( {P}_{line , b}^{t} - {\tilde{I}}_{line , b}^{t} {R}_{line , b} ) = {P}_{n , out}^{t} , ∀ n ∈ {Ω}_{e}^{node} ;$$

$${\tilde{I}}_{line , l}^{t} = {( {I}_{line , l}^{t} )}^{2} , ∀ l ( i , j ) ∈ {Ω}_{e}^{line} ;$$

$${\tilde{U}}_{n}^{t} = {( {U}_{n}^{t} )}^{2} , ∀ n ∈ {Ω}_{e}^{node} ;$$

$${‖ \begin{matrix}2 {P}_{line , l}^{t} \\ {\tilde{I}}_{line , l}^{t} - {\tilde{U}}_{i}^{t}\end{matrix} ‖}_{2} \leq {\tilde{I}}_{line , l}^{t} + {\tilde{U}}_{i}^{t} , ∀ l ( i , j ) ∈ {Ω}_{e}^{line} ;$$

$$\vert {P}_{line , l}^{t} \vert \leq {P}_{line , max} , ∀ l ( i , j ) ∈ {Ω}_{e}^{line} ;$$

$$0 \leq {\tilde{I}}_{line , l}^{t} \leq {\tilde{I}}_{line , max} , ∀ l ( i , j ) ∈ {Ω}_{e}^{line} ; and$$

$$0 \leq {\tilde{U}}_{n}^{t} \leq {\tilde{U}}_{max} , ∀ n ∈ {Ω}_{e}^{node} ,$$

where

$${I}_{line}^{t}$$

represents a branch current at the moment t,

$${R}_{line , 1} and {X}_{line , 1}$$

represent a resistor and a reactor of a branch 1,

$${P}_{line}^{t} and {Q}_{line}^{t}$$

represent active power and reactive power flowing through the branch, and

$${U}_{i}^{t} and {U}_{j}^{t}$$

are voltages of nodes i and j at the moment t respectively;

$${Ω}_{e}^{line}$$

represents a set of all branches of the power distribution network;

$${Ω}_{e}^{node}$$

represents a set of all nodes of the power distribution network, and

$${P}_{n , out}^{t} and {Q}_{n , out}^{t}$$

are active power and reactive power of a net outflow node n; and P_{line,max} is maximum active power that the branch withstands, and Ĩ_{line,max} and Ũₘₐₓ are squares of maximum values allowable by a current and a voltage respectively.

As a preferred solution of the method for constructing an optimal scheduling model of an integrated energy system considering virtual thermal storage of the disclosure, the objective function is as follows:

$$min f = {f}_{MTESD , TSS} + {f}_{buy} + {f}_{ECD} + {f}_{DG} + {f}_{pun} - {f}_{env} + {f}_{IDR} - {f}_{EV} ;$$

$${f}_{MTESD , TSS} = {\sum }_{t = 1}^{T} {c}_{TSS} ( \vert {H}_{c}^{t} \vert + \vert {H}_{dis}^{t} \vert ) Δ t ;$$

$${f}_{buy} = {\sum }_{t = 1}^{T} ( {c}_{E} {P}_{grid}^{t} + {c}_{G} {G}_{grid}^{t} ) Δ t ;$$

$${f}_{ECD} = {\sum }_{t = 1}^{T} ( {c}_{EH} {P}_{EH}^{t} + {c}_{P 2 G} {P}_{P 2 G}^{t} + {c}_{CB} {H}_{GB}^{t} ) Δ t ;$$

$${f}_{DG} = {\sum }_{t = 1}^{T} ( {c}_{WTG} {P}_{WTG}^{t} + {c}_{CHP} {P}_{CHP}^{t} + {c}_{PV} {H}_{PV}^{t} ) Δ t ;$$

$${f}_{pun} = {\sum }_{t = 1}^{T} ( {c}_{pun} {P}_{WTGwaste}^{t} + {c}_{pun} {P}_{PVwaste}^{t} ) Δ t ;$$

$${f}_{env} = {\sum }_{t = 1}^{T} ( {eP}_{PV}^{t} + {eP}_{WTG}^{t} ) Δ t ;$$

$${f}_{IDR} = {\sum }_{t = 1}^{T} {c}_{IDR} [ ( \vert {P}_{int}^{t} \vert + \vert {P}_{shi}^{t} \vert + \vert {H}_{int}^{t} \vert + \vert {H}_{shi}^{t} \vert + \vert {G}_{int}^{t} \vert + \vert {G}_{shi}^{t} \vert ) ] Δ t + {c}_{cha , IDR} ( 1 - {η}_{IDR}^{E - H} - {η}_{IDR}^{E - G} ) \vert {P}_{cha}^{t} \vert Δ t ; and$$

$${f}_{EV} = {\sum }_{t = 1}^{T} {c}_{EV} {P}_{EV}^{t} Δ t ,$$

where
f is total scheduling cost, f_{MTESD,TSS} is operation and maintenance cost of a physical thermal storage system in a multi-type energy storage apparatus, f_{buy} is electricity and gas purchase expenses, i.e. cost of electricity and gas purchased from a superior power grid and a natural gas network, f_{ECD} is operation cost of an energy conversion apparatus, f_{DG} is operation and maintenance cost of distributed power generation, fₚᵤₙ is penalty cost of wind rejection and light rejection, fₑₙᵥ is environmental benefit income of renewable energy, f_{IDR} is compensation cost of integrated demand response, and f_{EV} is profit obtained by an integrated energy operator selling electricity to an EV operator; c_{TSS} is unit power operation and maintenance cost of the thermal storage system;

$${P}_{grid}^{t}$$

is an amount of electricity purchased from the superior power grid,

$${G}_{grid}^{t}$$

is an amount of gas purchased from the natural gas network, and c_{E} and c_{G} are unit electricity price and gas price respectively; c_{EH}, c_{P2G} and c_{GB} are unit power operation and maintenance cost of energy conversion apparatuses of (EH), the P2G and the GB respectively; c_{WTG}, c_{CHP} and c_{PV} are unit power operation and maintenance cost of distributed sources of the wind turbine, the combined heat and power unit and the photovoltaic generator set; cₚᵤₙ is a penalty coefficient for wind rejection and light rejection; e is an environmental benefit coefficient of renewable energy such as wind power and the photovoltaic;

$${H}_{int}^{t} , {H}_{shi}^{t} , {G}_{int}^{t} and {G}_{shi}^{t}$$

are participation power of the reducible load and the transferable load in heat and gas integrated demand response respectively, and c_{IDR} is a unit power compensation cost coefficient of the integrated demand response; and c_{EV} is unit power income of the integrated energy operator selling the electricity to the EV operator.

In order to further solve the above technical problem, the disclosure provides the following technical solution: a system for constructing an optimal scheduling model of an integrated energy system considering virtual thermal storage includes: a model establishment module, configured to establish an operation model of a working apparatus of the integrated energy system, establish an integrated demand response model of an integrated energy load and an orderly charging model of an EV, and establish an energy flow calculation model of a heat supply network considering the virtual thermal storage; a power flow processing module, configured to process, based on a mathematical theory, a direct current power flow model of a power distribution network, and transform a general power flow constraint into a mixed integer quadratic constraint programming constraint according to a second-order cone relaxation method; and an optimal scheduling module, configured to construct, according to power flow constraints of the power distribution network, the heat supply network and a gas network of the integrated energy system, the optimal scheduling model of the integrated energy system considering the virtual thermal storage by taking minimization of total operation cost of an integrated energy operator as an objective function.

A computer device includes a memory and a processor, where the memory stores a computer program, and the processor implements steps of the method for constructing an optimal scheduling model of an integrated energy system considering virtual thermal storage described above when executing the computer program.

A computer-readable storage medium stores a computer program, where the computer program implements steps of the method for constructing an optimal scheduling model of an integrated energy system considering virtual thermal storage described above when executed by a processor.

The disclosure has the beneficial effects: the disclosure constructs the optimal scheduling model by taking the minimization of the total operation cost as an objective by establishing the operation model of the working apparatus of the system, the demand response model of the load, the charging model of the EV and the energy flow calculation model of the heat supply network considering the virtual thermal storage and processing the power flow constraint of the power distribution network according to the mathematical method. The method comprehensively considers factors of characteristics of various apparatuses in the system, demand response, EV charging, the virtual energy storage of the heat supply network, etc., and can describe operation characteristics of the integrated energy system more accurately, thereby coordinately and optimally scheduling a plurality of energy sources, improving economic efficiency, environmental friendliness and reliability of the system, and providing support for efficient operation of the integrated energy system.

### BRIEF DESCRIPTION OF DRAWINGS

In order to describe the technical solutions of the examples of the disclosure more clearly, the accompanying drawings required for describing the examples are briefly described below. Obviously, the accompanying drawings in the following description show merely some examples of the disclosure, and those of ordinary skill in the art would further be able to derive other accompanying drawings from these accompanying drawings without making creative efforts.

FIG. 1 is a structural diagram showing node voltage vectors and a network of a method for constructing an optimal scheduling model of an integrated energy system considering virtual thermal storage according to an example of the disclosure;

FIG. 2 is a schematic flow diagram of a method for constructing an optimal scheduling model of an integrated energy system considering virtual thermal storage according to an exemplary example of the disclosure;

FIG. 3 is a schematic diagram showing an urban integrated energy network topology according to an exemplary example of the disclosure;

FIG. 4 is a schematic diagram showing electric load, thermal load, gas load, photovoltaic and wind power curves, an electricity price curve, etc. under a typical operation scenario according to an exemplary example of the disclosure; and

FIGS. 5a-5c is a schematic diagram showing optimal scheduling strategies of electricity, heat and gas of an integrated energy system according to an exemplary example of the disclosure.

### DETAILED DESCRIPTION OF THE EMBODIMENTS

In order to make the above objectives, features, and advantages of the disclosure more apparent and easily understood, particular embodiments of the disclosure will be described in detail below in combination with the accompanying drawings of the description. Obviously, the examples described are some examples rather than all examples of the disclosure. Based on the examples of the disclosure, all other examples obtained by those of ordinary skill in the art without making inventive efforts should all fall within the scope of protection of the disclosure.

A number of specific details are set forth in the following description to fully understand the disclosure, but the disclosure can be further implemented in other ways different from those described herein, similar derivatives can be made by those skilled in the art without departing from the connotation of the disclosure, and thus the disclosure is not limited by the particular examples disclosed below.

### Example 1

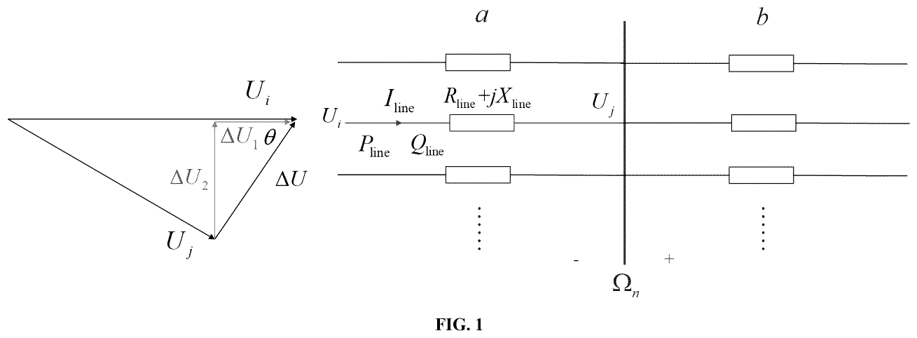

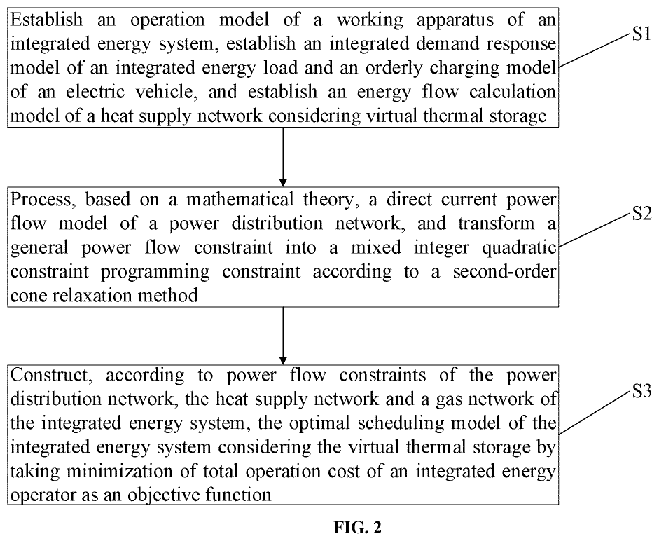

With reference to FIGS. 1-4 and FIGS. 5a-5c, an example of the disclosure is provided. A method for constructing an optimal scheduling model of an integrated energy system (IES) considering virtual thermal storage is provided. The method includes:
S1: an operation model of a working apparatus of the IES is established, an integrated demand response (IDR) model of an integrated energy load and an orderly charging model of an electric vehicle (EV) are established, and an energy flow calculation model of a heat supply network considering the virtual thermal storage is established.
S1.1: the operation model of the working apparatus of the IES is established.

The operation model of the working apparatus of the IES includes a wind turbine model, a photovoltaic generator set model, a combined heat and power (CHP) unit model, a gas boiler (GB) model, an electric heater (EH) model, a power to gas (P2G) apparatus model, an energy storage system (ESS) model, and a thermal storage system (TSS) model.

A wind turbine generator is a type of clean renewable energy, and occupies an important position in an energy structure of China. Wind power drives a turbine and converts mechanical energy into electric energy by means of a generator. In the process, a speed increaser is responsible for increasing a turbine speed, so as to make the generator reach an operation condition. The electric energy is connected to a grid by means of a transformer and a power electronic device. A control system monitors and controls operation of the whole wind turbine generator to ensure safe and stable power generation. The wind turbine model is represented by the following formulas:

$$P = \frac{1}{2} ρ {Sv}^{3} ;$$

$${η}_{max} = \frac{{P}_{max}}{P} = 0.593 ;$$

$$P = \frac{1}{2} {η}_{w} ρ {Sv}^{3} ;$$

$${P}_{WTG} ( v ) = \{ \begin{matrix}0 ( v \leq {v}_{ci} , v \geq {v}_{co} ) \\ \frac{{v}^{3} - {v}_{ci}^{3}}{{v}_{r}^{3} - {v}_{ci}^{3}} {P}_{r} ( {v}_{ci} \leq v \leq {v}_{r} ) \\ {P}_{r} ( {v}_{r} \leq v \leq {v}_{co} )\end{matrix} ;$$

$${P}_{WTGtotal}^{t} = {P}_{WTG}^{t} + {P}_{WTGwaste}^{t} ; and$$

$$\vert {P}_{WTG}^{t} - {P}_{WTG}^{t - 1} \vert \leq {P}_{WTG , climb} .$$

v is a wind speed of a wind turbine, S represents a swept area, and ρ is an air density; ηₘₐₓ is a maximum utilization rate of wind energy, and Pₘₐₓ is maximum output power; η_{w} is a utilization rate of the wind energy; Pᵣ and P_{WTG}(V) are rated power and actual power of the wind turbine respectively, v and vᵣ are an actual wind speed and a rated wind speed of the wind turbine respectively, and v_{ci} and v_{co} are an inflow wind speed and an outflow wind speed of the wind turbine respectively;

$${P}_{PVtotal}^{t}$$

is total output power,

$${P}_{PV}^{t}$$

is actual output power, and

$${P}_{PVwaste}^{t}$$

is light rejection power; P_{WTG,climb} and is an upper limit of a climbing constraint.

Photovoltaic power generation is a multifunctional solar energy technology, converts solar energy into electric energy by means of a battery panel, requires no fuel, and has excellent environmental benefits. The control system monitors and adjusts energy conversion and output of photovoltaic power generation to ensure stable operation of the photovoltaic power generation. Power conversion apparatuses such as a power distribution cabinet and an inverter convert direct current into alternating current, and are connected to the grid after boosted by means of a boosting transformer. The photovoltaic generator set model is represented by the following formulas:

$${P}_{PVtotal}^{t} = {P}_{PV}^{t} + {P}_{PVwaste}^{t} , \\ and \\ \vert {P}_{PV}^{t} - {P}_{PV}^{t - 1} \vert \leq {P}_{PV , climb} .$$

$${P}_{PVtotal}^{t}$$

is total output power of a photovoltaic,

$${P}_{P V}^{t}$$

is actual output power, and

$${P}_{PVwaste}^{t}$$

is light rejection power; and P_{PV,climb} is an upper limit of a climbing constraint of the photovoltaic.

As a distributed output apparatus, a CHP unit consumes natural gas power in operation, and simultaneously generates electric power and thermal power. Compared with a traditional distributed output apparatus, the CHP unit features a high energy utilization rate and low pollution discharge, and is widely used in the IES. Since heat energy and electric energy of the CHP unit are simultaneously generated, it is considered that the CHP unit has two operation modes of “power determined by heat” or “heat determined by power”, and the CUP unit has relatively poor adjustability in a scheduling process of the IES. A large amount of output of the CHP unit may crowd out output of new energy, resulting in frequent occurrence of “wind rejection” and “light rejection”. The CHP unit model is represented by the following formulas:

$${P}_{CHP}^{t} = {η}_{CHP}^{E - H} {H}_{CHP}^{t} = {η}_{CHP}^{E - H} ( {η}_{CHP}^{H - G} {G}_{CHP}^{t} ) ; \\ {P}_{CHP , min} \leq {P}_{CHP}^{t} \leq {P}_{CHP , max} ; \\ \vert {P}_{CHP}^{t} - {P}_{CHP}^{t - 1} \vert \leq {P}_{CHP}^{climb , max} ; \\ and \\ {H}_{CHP}^{t} = {H}_{CHP - TSS}^{t} + {H}_{CHP - Load}^{t} .$$

$${P}_{CHP}^{t}$$

is electric power generated by a CHP unit,

$${H}_{CHP}^{t}$$

is thermal power generated by the CUP unit,

$${G}_{CHP}^{t}$$

is gas power consumed by the CHP unit,

$${η}_{CHP}^{E - H}$$

is an electricity-heat proportion coefficient, and

$${η}_{CHP}^{H - G}$$

is a gas-heat conversion coefficient; P_{CHP,min} and P_{CHP,max} represent a lower limit and an upper limit of an output of the electric power of the CHP unit respectively;

$${P}_{CHP}^{climb , max}$$

represents an upper limit of a climbing rate of the electric power of the CHP unit; and

$${H}_{CHP}^{t}$$

is total heat output power of the CHP unit,

$${H}_{CHP - Load}^{t}$$

is power at which a thermal load is supplied, and

$${H}_{CHP - TSS}^{t}$$

is power at which the thermal load is stored into a TSS.

The GB model is represented by the following formulas:

$${H}_{GB}^{t} = {η}_{GB} {G}_{GB}^{t} ;$$

$$and$$

$${H}_{GB , min} \leq {H}_{GB}^{t} \leq {H}_{GB , max} .$$

$${H}_{GB}^{t}$$

is thermal power generated by a GB,

$${G}_{GB}^{t}$$

is gas power consumed by the GB, and η_{GB} is a gas-heat conversion coefficient of the GB; and H_{GB,min} and H_{GB,max} represent a lower limit and an upper limit of an output of the thermal power of the GB.

Preferably, the GB consumes gas power to produce thermal power by means of natural gas as a fuel. A working principle of the GB is that gas is combusted to heat water, such that a temperature of the water is increased, and the gas is converted into heat energy. That is, the heat energy generated by combustion of the gas is transferred to the water, thereby increasing the temperature of the water.

The EH model is represented by the following formulas:

$${H}_{EH}^{t} = {η}_{EH} {P}_{EH}^{t} ;$$

$$and$$

$${P}_{EH , min} \leq {P}_{EH}^{t} \leq {P}_{EH , max} .$$

$${H}_{EH}^{t}$$

is thermal power generated by an EH,

$${P}_{EH}^{t}$$

is electric power consumed by the EH, and η_{EH} is an electricity-heat conversion coefficient of the EH; and P_{EH,min} and P_{EH,max} represent a lower limit and an upper limit of the electric power consumed by the EH respectively.

Preferably, the EH converts electric energy into heat energy according to an electromagnetic induction principle, and is an energy conversion device. The EH has characteristics including a small size, numerous varieties, a simple structure, and easy assembly. Compared with a traditional boiler, the EH has the advantages of high heating efficiency, cleanliness and environmental friendliness.

The P2G apparatus model is represented by the following formulas:

$${G}_{P 2 G}^{t} = {η}_{P 2 G} {P}_{P 2 G}^{t} ;$$

$$and$$

$${P}_{P 2 G , min} \leq {P}_{P 2 G}^{t} \leq {P}_{P 2 G , max} .$$

$${G}_{P 2 G}^{t}$$

is gas powered generated by P2G,

$${P}_{P 2 G}^{t}$$

is electric power consumed by the P2G, and η_{P2G} is an electricity-gas conversion coefficient of the EH; and P_{P2G,min} andP_{P2G,max} represent a lower limit and an upper limit of the electric power consumed by the P2G respectively.

Preferably, the P2G apparatus is a key apparatus for interconnection of an electric system and a gas system, and the P2G may convert electric power into natural gas power. The P2G becomes an important energy coupling unit by means of flexible adjustability of the P2G, and an operation mode may be flexibly adjusted according to a load demand and gas supply. A common P2G technology is that carbon dioxide and hydrogen react to produce methane, and the methane is conveyed to a gas pipeline to achieve energy conversion between an electric power system and the gas network, such that the electric power system and a natural gas system may be in butt joint more closely. Thus, the energy is effectively converted and utilized. In the actual IES, the P2G apparatus has to have a certain amount of participation, but in view of limitations of the upper limit and the lower limit of the output, the P2G apparatus generally participates in not extremely large conversion power, and only has an effect of small adjustment.

The ESS model is represented by the following formulas:

$${C}_{SOC}^{t} = ( 1 − γ ) {C}_{SOC}^{t − 1} + λ {P}_{c}^{t} Δ t − \frac{{P}_{dis}^{t}}{λ} Δ t ;$$

$${P}_{c}^{t} {P}_{dis}^{t} = 0 ;$$

$${C}_{SOC}^{0} = {C}_{SOC}^{T} ;$$

$${C}_{SOC , min} \leq {C}_{SOC}^{t} \leq {C}_{SOC , max} ;$$

$${P}_{c}^{t} \leq {P}_{c , max} ;$$

$$and$$

$${P}_{dis}^{t} \leq {P}_{ds , max} .$$

$${C}_{SOC}^{t} and {C}_{SOC}^{t - 1}$$

represent states of charges (SOCs) of a battery at a moment t and a moment t−1 respectively,

$${P}_{c}^{t} and {P}_{dis}^{t}$$

represent charge power and discharge power at the moment t respectively, γ is an electric energy dissipation coefficient of the energy storage system, λ is a charge and discharge efficiency coefficient of the battery, and Δt is unit scheduling time; and T represents a scheduling period,

$${C}_{SOC}^{0} and {C}_{SOC}^{T}$$

represent SOCs of the energy storage system at a beginning and an end of the scheduling period respectively, c_{SOC,min} and c_{SOC,max} represent a lower limit and an upper limit of the SOC of the energy storage system, P_{c,max} is an upper limit of the charge power of the energy storage system, and P_{dis,max} is an upper limit of the discharge power of the energy storage system.

Since most of energy conversion may be achieved in a form of heat energy, a thermal storage technology is considered to be a most simple way of energy storage, has an extremely important effect in the increasingly severe energy problem, and becomes an essential apparatus in the IES. The TSS is represented by the following formulas:

$${C}_{TSS}^{t} = ( 1 − β ) {C}_{TSS}^{t − 1} + {H}_{c}^{t} Δ t − {H}_{dis}^{t} Δ t ;$$

$${H}_{c}^{t} {H}_{dis}^{t} = 0 ;$$

$${C}_{TSS}^{0} = {C}_{TSS}^{T} ;$$

$${C}_{TSS , min} \leq {C}_{TSS}^{t} \leq {C}_{TSS , max} ;$$

$${H}_{c}^{t} \leq {H}_{c , max} ;$$

$$and$$

$${H}_{dis}^{t} \leq {H}_{dis , max} .$$

$${C}_{TSS}^{t} and {C}_{TSS}^{t - 1}$$

represent thermal storage amounts of the thermal storage system at the moment t and the moment t−1 respectively,

$${H}_{c}^{t} and {H}_{dis}^{t}$$

represent thermal storage power and thermal release power of the thermal storage system at the moment t respectively, and β is a dissipation coefficient of the thermal storage system; and

$${C}_{TSS}^{0} and {C}_{TSS}^{T}$$

represent thermal storage amounts of the thermal storage system at the beginning and the end of the scheduling period respectively, c_{TSS,min} and c_{TSS,max} represent a lower limit and an upper limit of the thermal storage amount of the thermal storage system, H_{c,max} is an upper limit of the thermal storage power of the thermal storage system, and H_{dis,max} is an upper limit of the thermal release power of the thermal storage system.
S1.2: the IDR model of the integrated energy load and the orderly charging model of the EV are established.

Specifically, the IDR model of the integrated energy load is as follows: IDR on a demand side refers to extension of a demand response of a general electric load to remaining types of loads in the IES such as electricity, gas and heat, so as to make full use of multi-energy complementary characteristics of the IES, and break through barriers between different types of energy. Thus, a higher energy utilization rate of demand side resources than a traditional electric load demand response is achieved. There are a variety of classification ways of the IDR. One way is to divide electric loads, thermal loads and gas loads into a conventional load, a reducible load and a transferable load respectively. The reducible load refers to part of integrated energy loads that may be directly reduced based on cost compensation when the load is high; and the transferable load refers to part of the loads that may be transferred to the remaining scheduling periods of time based on cost compensation when the load is high. Another classification way is to classify the loads of the IES into a fixed load, a price-based load and a substitutional load. For the price-based load, a user may be prompted to adjust an energy consumption behavior by changing time-sharing energy price; and for the substitutional load, the user may provide the same energy demand by selecting different forms of energy. The reducible load, the transferable load and the substitutional load are mainly considered for the IDR of the load in the disclosure. The transferable load is only allowed to participate in adjustment in part of periods of time of 24 h. The IDR model of the integrated energy load is represented by the following formulas:

$${P}_{IDR}^{t} = {P}_{IDR}^{t , int} + {P}_{IDR}^{t , shi} + {P}_{IDR}^{t , cha} ;$$

$$0 \leq {P}_{IDR}^{t , int} \leq {γ}_{IDR}^{int} {P}_{L}^{t} ;$$

$${P}_{IDR}^{t , shi} = {P}_{IDRout}^{t , shi} − {P}_{IDRin}^{t , shi} ;$$

$${P}_{IDRout}^{t , shi} {P}_{IDRin}^{t , shi} = 0$$

$${\sum }_{t = 1}^{T} {P}_{IDR o u t}^{t , shi} = {\sum }_{t = 1}^{T} {P}_{IDRin}^{t , shi} ;$$

$$0 \leq {P}_{IDR}^{t , shi} \leq {P}_{IDR}^{shi , max} ;$$

$$0 \leq {P}_{IDR}^{t , cha} \leq {γ}_{IDR}^{cha} {P}_{L}^{t} ;$$

$${P}_{L}^{t , actual} = \qquad {P}_{L}^{t} − {P}_{IDR}^{t , int} − {P}_{IDR}^{t , shi} − {P}_{IDR}^{t , cha} ;$$

$${H}_{IDR}^{t , cha} = {η}_{IDR}^{E − H} {P}_{IDR}^{t , cha} ;$$

$${G}_{IDR}^{t , cha} = {η}_{IDR}^{E − G} {P}_{IDR}^{t , cha} ;$$

$${H}_{L}^{t , actual} = \qquad {H}_{L}^{t} − {H}_{IDR}^{t , int} − {H}_{IDR}^{i , shi} + {H}_{IDR}^{t , cha} ;$$

$${G}_{L}^{t , actual} = \qquad {G}_{L}^{t} − {G}_{IDR}^{i , int} − {G}_{IDR}^{t , shi} + {G}_{IDR}^{t , cha} ;$$

$$and$$

$${η}_{IDR}^{E − H} + {η}_{IDR}^{E − G} \leq 1.$$

$${P}_{IDR}^{t , int} , {P}_{IDR}^{t , shi} and {P}_{IDR}^{t , cha}$$

represent a reducible load, a transferable load and a substitutional load respectively;

$${γ}_{IDR}^{int}$$

is a maximum participation proportion coefficient of the reducible load, and

$${P}_{L}^{t}$$

is a total electric load at the moment t;

$${P}_{IDR}^{shi , max}$$

is a maximum participation value of the transferable load;

$${γ}_{IDR}^{cha}$$

is a maximum participation proportion coefficient of the substitutional load;

$${H}_{IDR}^{t , cha}$$

is thermal load power converted from the substitutional load, and

$${η}_{IDR}^{E − H}$$

is an electricity-heat conversion coefficient of the substitutional load; and

$${G}_{IDR}^{t , cha}$$

is gas load power converted from the substitutional load, and

$${η}_{IDR}^{E − G}$$

is an electricity-gas conversion coefficient.

The orderly charging model of the EV is represented by the following formulas:

$$( {C}_{EVSOC}^{out , k} − {C}_{EVSOC}^{in , k} ) {E}_{k} \leq {W}_{EV}^{k} \leq ( 1 − {C}_{EVSOC}^{in , k} ) {E}_{k} ;$$

$$( {C}_{EVSOC}^{t , k} − {C}_{EVSOC}^{t − 1 , k} ) {E}_{k} = {α}_{k , t} {p}_{k , t} Δ t ;$$

$${W}_{EV}^{k} = {\sum }_{i = 1}^{{T}_{k}} {α}_{k , t} {p}_{k , t} Δ t ;$$

$$and$$

$${P}_{EV}^{t} = {\sum }_{k = 1}^{{N}_{EV}} {α}_{k , t} {p}_{k , t} Δ t .$$

k is a number of the EV,

$${C}_{EVSOC}^{out , k}$$

represents a percentage of a minimum off-grid SOC specified by an EV user having the number of k in battery capacity,

$${C}_{EVSOC}^{in , k}$$

represents a percentage of an on-grid SOC of the EV in the battery capacity, Eₖ is the battery capacity, and

$${W}_{EV}^{k}$$

is a total charge demand of the user;

$${C}_{EVSOC}^{t , k} and {C}_{EVSOC}^{t - 1 , k}$$

are SOCs of the vehicle k in a period of time t and a period of time t−1 respectively; p_{k,t} is average charge and discharge power of the EV in a fast charge mode; is a α_{k,t} variable representing charging or occupation, i.e. an identifier, is valued as 0 or 1, and represents that the vehicle is in an occupied state and a charge state respectively; Tₖ represents the total number of periods of time during which the vehicle k is accessed to a power grid; and N_{EV} represents the number of EVs.

It should be noted that the EV considered in the disclosure is considered to be in an urban complex station, and a net charge amount range required by the EV after the EV arrives at a charging pile of the urban complex station is determined by an on-grid SOC, a minimum off-grid SOC specified by the user, and the battery capacity.
S1.3: the energy flow calculation model of the heat supply network considering the virtual thermal storage is established.

Specifically, a power exchange model of an initial heat exchange station and a heat exchange station is as follows:

$$( {H}_{CHP}^{t} + {H}_{EH - Load}^{t} + {H}_{dis}^{t} + {H}_{GB}^{t} ) Δ t = {c}_{w} {m}_{HS}^{t} ( {T}_{HS , in}^{t , S} - {T}_{HS , out}^{t , R} ) ; \\ and \\ {c}_{w} {m}_{HES}^{t} ( {T}_{HES out}^{t , S} - {T}_{HES in}^{t , R} ) = {H}_{L}^{t} Δ t .$$

$${T}_{HS , in}^{t , S} and {T}_{HS , out}^{t , R}$$

are an unlet temperature in a water supply pipeline and an outlet temperature in a water return pipeline connected to the initial heat exchange station respectively;

$${m}_{HS}^{t}$$

is a flow rate of water flowing through the initial heat exchange station; c_{w} is specific heat capacity of the water;

$${T}_{HESout}^{t , S} and {T}_{HES in}^{t , R}$$

and are an outlet temperature in the water supply pipeline and an inlet temperature in the water return pipeline connected to the heat exchange station respectively;

$${m}_{HES}^{t}$$

is a flow rate of hot water flowing through the heat exchange station; and

$${H}_{L}^{t}$$

is a thermal load at the moment t;
a temperature mixing constraint and a range constraint are as follows:

$${\sum }_{j ∈ {Ω}_{h , n}^{pipe -}} {T}_{j , out}^{t} {q}_{j} = {T}_{k , in}^{t} {\sum }_{k ∈ {Ω}_{h , n}^{pipe +}} {q}_{k} ; \\ {T}_{min}^{S} \leq {T}_{p}^{t , S} \leq {T}_{max}^{S} , ∀ p ∈ {Ω}_{h}^{pipe} ; \\ and \\ {T}_{min}^{R} \leq {T}_{p}^{t , R} \leq {T}_{max}^{R} , ∀ p ∈ {Ω}_{h}^{pipe} .$$

$${Ω}_{h , n}^{pipe +} and {Ω}_{h , n}^{pipe -}$$

represent pipeline sets starting from and ending at a node n in the heat supply network respectively;

$${T}_{k , in}^{t}$$

is an inlet temperature of a water supply pipeline k at the moment t; qₖ and qⱼ are flow rates of water supply pipelines k and j respectively, which are kept constant; T_{j,out}^{t} is an outlet temperature of the water supply pipeline at the moment t;

$${T}_{max}^{S} and {T}_{min}^{S}$$

are an upper limit and a lower limit of a temperature of the water supply pipeline respectively; and

$${T}_{max}^{R} and {T}_{min}^{R}$$

are an upper limit and a lower limit of a temperature of the water return pipeline respectively.

Optionally, according to a node method, the heat supply network considering transmission delay and temperature loss is modeled as follows:

$${τ}_{p}^{S} = \frac{{l}_{p}^{S} {S}_{p}^{S} {ρ}_{w}}{{q}_{p}^{S} Δ t} ;$$

$$K = ⌈ {τ}_{p}^{S} ⌉ ;$$

$${τ}_{p}^{K - 1 , S} = ( K - 1 ) Δ t ;$$

$${τ}_{p}^{K , S} = K Δ t ;$$

$${T}_{p , out}^{t , K , S} = {e}^{- {k}_{p}^{S} {l}_{p}^{S} / {q}_{p}^{S} {c}_{w}} ( {T}_{p , in}^{t - ( K - 1 ) , S} - {T}_{env}^{t} ) + {T}_{env}^{t} ;$$

$${T}_{p , out}^{t , S} = {W}_{1} {W}_{3} {T}_{p , in}^{t - ( K - 1 ) , S} + {W}_{2} {W}_{3} {T}_{p , in}^{t - ( K - 1 ) , S} + ( 1 - {W}_{1} {W}_{3} - {W}_{2} {W}_{3} ) {T}_{env}^{t} ;$$

$${W}_{1} = \frac{{q}_{p}^{S} ( {τ}_{p}^{K , S} - {τ}_{p}^{S} )}{[ {q}_{p}^{S} ( {τ}_{p}^{K , S} - {τ}_{p}^{S} ) + {q}_{p + 1}^{S} ( {τ}_{p}^{S} - {τ}_{p}^{K - 1 , S} ) ]} ;$$

$${W}_{2} = \frac{{q}_{p + 1}^{S} ( {τ}_{p}^{S} - {τ}_{p}^{K - 1 , S} )}{[ {q}_{p}^{S} ( {τ}_{p}^{K , S} - {τ}_{p}^{S} ) + {q}_{p + 1}^{S} ( {τ}_{p}^{S} - {τ}_{p}^{K - 1 , S} ) ]} ; and$$

$${W}_{3} = {e}^{- {k}_{p}^{S} {l}_{p}^{S} / {q}_{p}^{S} {c}_{w}} .$$

A superscript S only represents the water supply pipeline, a subscript p only represents a pipeline p, and a physical meaning of each symbol is kept consistent with that of the above;

$${τ}_{p}^{S}$$

is a transmission delay time constant of a whole pipeline, and

$${l}_{p}^{S} and {S}_{p}^{S}$$

represent a length and a cross-sectional area of the water supply pipeline p respectively; ρ_{w} is a density of water;

$${T}_{p , in}^{t - ( K - 1 ) , S}$$

is an inlet temperature of hot water in the water supply pipeline p at a period of time t−(K−1);

$${k}_{p}^{S}$$

is a temperature loss coefficient of the pipeline p; and

$${T}_{env}^{t}$$

is an ambient temperature of a district heat supply network.

By means of sorting,

$${T}_{p , out}^{t , S} = \frac{{τ}_{p}^{K , S} - {τ}_{p}^{S}}{Δ t} {e}^{- \frac{{k}_{p}^{S} {l}_{p}^{S}}{{q}_{p}^{S} {c}_{w}}} ( \frac{{T}_{p , out}^{t , K , S} - {T}_{env}^{t}}{{e}^{- \frac{{k}_{p}^{S} {l}_{p}^{S}}{{q}_{p}^{S} {c}_{w}}}} + {T}_{env}^{t} ) + \frac{{τ}_{p}^{S} - {τ}_{p}^{K - 1 , S}}{Δ t} {e}^{- \frac{{k}_{p}^{S} {l}_{p}^{S}}{{q}_{p}^{S} {c}_{w}}} ( \frac{{T}_{p , out}^{t , K + 1 , S} - {T}_{env}^{t}}{{e}^{- \frac{{k}_{p}^{S} {l}_{p}^{S}}{{q}_{p}^{S} {c}_{w}}}} + {T}_{env}^{t} ) may be + [ 1 - \frac{{τ}_{p}^{K , S} - {τ}_{p}^{S}}{Δ t} {e}^{- \frac{{k}_{p}^{S} {l}_{p}^{S}}{{q}_{p}^{S} {c}_{w}}} - \frac{{τ}_{p}^{S} - {τ}_{p}^{K - 1 , S}}{Δ t} {e}^{- \frac{{k}_{p}^{S} {l}_{p}^{S}}{{q}_{p}^{S} {c}_{w}}} ] {T}_{env}^{t} obtained .$$

Pipeline energy storage of the heat supply network is as follows:

$${H}_{PES}^{t} = {\sum }_{p , q ∈ {Ω}_{h}^{pipe}} {c}_{w} [ {q}_{p}^{S} ( {T}_{p , out}^{t , S} - {T}_{p , in}^{t , S} ) + {q}_{q}^{R} ( {T}_{q , out}^{t , R} - {T}_{q , in}^{t , R} ) ] Δ t .$$

$${H}_{PES}^{t}$$

represents the pipeline energy storage of the heat supply network; a superscript R only represents the water return pipeline of the heat supply network, and a physical meaning of each symbol is kept consistent with that of the above; and

$${Ω}_{h}^{pipe}$$

is any group of pipeline sets in the heat supply network.

Upper and lower limit constraints and periodic recovery constraints of the pipeline energy storage of the district heat supply network are as follows:

$${H}_{PES , min} \leq {H}_{PES}^{t} \leq {H}_{PES , max} ; and$$

$${H}_{PES}^{0} = {H}_{PES}^{T}$$

H_{PES,max} and H_{PES,min} represent an upper limit and a lower limit of the pipeline energy storage of the heat supply network respectively; and

$${H}_{PES}^{0} and {H}_{PES}^{T} .$$

are the pipeline energy storage of the heat supply network at the beginning and the end of the scheduling period respectively.
S2: a direct current power flow model of a power distribution network is processed based on a mathematical theory, and a general power flow constraint is transformed into a mixed integer quadratic constraint programming (MIQCP) constraint according to a second-order cone relaxation method.

In an example, in S2, the constructed direct current power flow model of the power distribution network is specifically as follows:

optionally, related expressions are written according to a structural diagram showing node voltage vectors and a network shown in FIG. 1.

$$\vert Δ U \vert = {I}_{line} \sqrt{{R}_{line}^{2} + {X}_{line}^{2}} ;$$

$${U}_{j} = {U}_{i} - \frac{{P}_{line} - {jQ}_{line}}{{U}_{i}} ( {R}_{line} - {jX}_{line} ) = {U}_{i} - {I}_{line} ( {R}_{line} + {jX}_{line} ) ;$$

$$cos θ = \frac{{U}_{i}^{2} + Δ {U}^{2} - {U}_{j}^{2}}{2 {U}_{i} Δ U} ;$$

$$Δ {U}_{1} = \frac{{P}_{line} {R}_{line} + {Q}_{line} {X}_{line}}{{U}_{i}} ; and$$

$$Δ {U}_{2} = \frac{{P}_{line} {X}_{line} + {Q}_{line} {R}_{line}}{{U}_{i}} .$$

ΔU represents a line drop, Iₗᵢₙₑ represents a branch current, Rₗᵢₙₑ and Xₗᵢₙₑ represent a resistor and a reactor of a branch, Pₗᵢₙₑ and Qₗᵢₙₑ represent active power and reactive power flowing through the branch, Uᵢ and Uⱼ represent voltages of nodes j and j respectively, ΔU₁ represents a vertical component of voltage drop, and ΔU₂ represents a transverse component of the voltage drop.

A power flow calculation constraint formula of the branch may be obtained:

$${U}_{j}^{2} = {U}_{i}^{2} - 2 ( {P}_{line} {R}_{line} + {Q}_{line} {X}_{line} ) + {l}_{line}^{2} ( {R}_{line}^{2} + {X}_{line}^{2} ) , ∀ l ( i , j ) ∈ {Ω}_{e}^{line} .$$

$${Ω}_{e}^{line}$$

represents a set of all branches of the power distribution network.

Balance formulas for the active power and the reactive power may be represented as:

$${\sum }_{a ∈ {Ω}_{n}^{+}} {P}_{line , a} - {\sum }_{b ∈ {Ω}_{n}^{-}} ( {P}_{line , b} - {l}_{line , b}^{2} {R}_{line , b} ) = {P}_{n , out} , ∀ n ∈ {Ω}_{e}^{node} , and$$

$${\sum }_{a ∈ {Ω}_{n}^{+}} {Q}_{line , a} - {\sum }_{b ∈ {Ω}_{n}^{-}} ( {Q}_{line , b} - {l}_{line , b}^{2} {R}_{line , b} ) = {Q}_{n , out} , ∀ n ∈ {Ω}_{e}^{node} .$$

$${Ω}_{e}^{node}$$

represents a set of all nodes of the power distribution network, and

$${Ω}_{n}^{+} and {Ω}_{n}^{-}$$

represent line sets by taking a node n as a head end and a tail end respectively. P_{n,out} and Q_{n,out} are the active power and the reactive power of a net outflow node n.

Since a related constraint of line power flow is nonlinear, it is difficult to solve the related constraint of the line power flow by means of a solver. Thus, the disclosure transforms the general power flow constraint into the MIQCP constraint according to the second-order cone relaxation method. Such a method is effective and reasonable by means of verification of actual solution, and successfully converts a non-convex problem into a convex problem. An optimal solution point is kept unchanged after relaxation, such that the related constraint of the line power flow can be solved by means of the solver. The constraint is represented as follows:

$${‖ \begin{matrix}\begin{matrix}2 {P}_{line} \\ 2 {Q}_{line}\end{matrix} \\ {I}_{line}^{2} - {U}_{i}^{2}\end{matrix} ‖}_{2} \leq {I}_{line}^{2} + {U}_{i}^{2} ,$$

The power flow constraint of the power distribution network in the IES of the disclosure uses the direct current power flow constraint, and completely ignores the reactive power in the power distribution network. For a part of a decision-making variable containing a square term, a whole square term is directly seen as a whole according to a method of variable replacement to write a constraint. A superscript of a related variable only represents a scheduling time interval, and physical meanings of remaining symbols are kept consistent.

$${\tilde{U}}_{j}^{t} = {\tilde{U}}_{i}^{t} - 2 {P}_{line , j}^{t} {R}_{line , j} + {I}_{line , j}^{t} {R}_{line , j}^{2} , ∀ l ( i , j ) ∈ {Ω}_{e}^{line} ;$$

$${\sum }_{a ∈ {Ω}_{n}^{+}} {P}_{line , a}^{t} - {\sum }_{b ∈ {Ω}_{n}^{-}} ( {P}_{line , b}^{t} - {\tilde{I}}_{line , b}^{t} {R}_{line , b} ) = {P}_{n , out}^{t} , ∀ n ∈ {Ω}_{e}^{node} ;$$

$${\tilde{I}}_{line , j}^{t} = {( {I}_{line , l}^{t} )}^{2} , ∀ l ( i , j ) ∈ {Ω}_{e}^{line} ;$$

$${\tilde{U}}_{n}^{t} = {( {U}_{n}^{t} )}^{2} , ∀ n ∈ {Ω}_{e}^{node} ;$$

$${‖ \begin{matrix}2 {P}_{line , l}^{t} \\ {\tilde{I}}_{line , l}^{t} - {\tilde{U}}_{i}^{t}\end{matrix} ‖}_{2} \leq {\tilde{I}}_{line , l}^{t} + {\tilde{U}}_{i}^{t} , ∀ l ( i , j ) ∈ {Ω}_{e}^{line} ;$$

$$\vert {P}_{line , l}^{t} \vert \leq {P}_{line , max} , ∀ l ( i , j ) ∈ {Ω}_{e}^{line} ;$$

$$0 \leq {\tilde{I}}_{line , l}^{t} \leq {\tilde{I}}_{line , max} , ∀ l ( i , j ) ∈ {Ω}_{e}^{line} ; and$$

$$0 \leq {\tilde{U}}_{n}^{t} \leq {\tilde{U}}_{max}^{t} , ∀ n ∈ {Ω}_{e}^{node} .$$

$${I}_{line}^{t}$$

represents a branch current at the moment t, R_{line,1} and X_{line,1} represent a resistor and a reactor of a branch 1,

$${P}_{line}^{t} and {Q}_{line}^{t}$$

represent active power and reactive power flowing through the branch, and

$${U}_{i}^{t} and {U}_{j}^{t}$$

are voltages of nodes i and j at the moment t respectively;

$${Ω}_{e}^{line}$$

represents a set of all branches of the power distribution network;

$${Ω}_{e}^{node}$$

represents a set of all nodes of the power distribution network, and

$${P}_{n , out}^{t} and {Q}_{n , out}^{t}$$

are active power and reactive power of a net outflow node n; and P_{line,max} is maximum active power that the branch withstands, and Ĩ_{line,max} and Ũₘₐₓ are squares of maximum values allowable by a current and a voltage respectively.
S3: according to power flow constraints of the power distribution network, the heat supply network and a gas network of the integrated energy system, the optimal scheduling model of the integrated energy system considering the virtual thermal storage is constructed by taking minimization of total operation cost of an integrated energy operator as an objective function.

Specifically, the objective function is as follows:

$$min f = {f}_{MTESD , TSS} + {f}_{buy} + {f}_{ECD} + {f}_{DG} + {f}_{pun} - {f}_{env} + {f}_{IDR} - {f}_{EV} ;$$

$${f}_{MTESD , TSS} = {\sum }_{t = 1}^{T} {c}_{TSS} ( \vert {H}_{c}^{t} \vert + \vert {H}_{dis}^{t} \vert ) Δ t ;$$

$${f}_{buy} = {\sum }_{t = 1}^{T} ( {c}_{E} {P}_{grid}^{t} + {c}_{G} {G}_{grid}^{t} ) Δ t ;$$

$${f}_{ECD} = {\sum }_{t = 1}^{T} ( {c}_{EH} {P}_{EH}^{t} + {c}_{P 2 G} {P}_{P 2 G}^{t} + {c}_{GB} {H}_{GB}^{t} ) Δ t ;$$

$${f}_{DG} = {\sum }_{t = 1}^{T} ( {c}_{WTG} {P}_{WTG}^{t} + {c}_{CHP} {P}_{CHP}^{t} + {c}_{PV} {P}_{PV}^{t} ) Δ t ;$$

$${f}_{pun} = {\sum }_{t = 1}^{T} ( {c}_{pun} {P}_{WTGwaste}^{t} + {c}_{pun} {P}_{PVwaste}^{t} ) Δ t ;$$

$${f}_{env} = {\sum }_{t = 1}^{T} ( {eP}_{PV}^{t} + {eP}_{WTG}^{t} ) Δ t ;$$

$${f}_{IDR} = {\sum }_{t = 1}^{T} {c}_{IDR} [ ( \vert {P}_{int}^{t} \vert + \vert {P}_{shi}^{t} \vert + \vert {H}_{int}^{t} \vert + \vert {H}_{shi}^{t} \vert + \vert {G}_{int}^{t} \vert + \vert {G}_{shi}^{t} \vert ) ] Δ t + {c}_{cha , IDR} ( 1 - {η}_{IDR}^{E - H} - {η}_{IDR}^{E - H} ) \vert {P}_{cha}^{t} \vert Δ t ; and$$

$${f}_{IDR} = {\sum }_{t = 1}^{T} {c}_{EV} {P}_{EV}^{t} Δ t .$$

f is total scheduling cost, f_{MTESD,TSS} is operation and maintenance cost of a physical TSS in a multi-type energy storage apparatus, f_{buy} is electricity and gas purchase expenses, i.e. cost of electricity and gas purchased from a superior power grid and a natural gas network, f_{ECD} is operation cost of an energy conversion apparatus, f_{DG} is operation and maintenance cost of distributed power generation, fₚᵤₙ is penalty cost of wind rejection and light rejection, fₑₙᵥ is environmental benefit income of renewable energy, f_{IDR} is compensation cost of integrated demand response, and f_{EV} is profit obtained by an integrated energy operator selling electricity to an EV operator; c_{TSS} is unit power operation and maintenance cost of the TSS;

$${P}_{grid}^{t}$$

is an amount of electricity purchased from the superior power grid,

$${G}_{grid}^{t}$$

is an amount of gas purchased from the natural gas network, and c_{E} and c_{G} are unit electricity price and gas price respectively; c_{EH} c_{P2G} and c_{GB} are unit power operation and maintenance cost of energy conversion apparatuses of (EH), the P2G and the GB respectively; c_{WTG}, c_{CHP} and c_{PV} are unit power operation and maintenance cost of distributed sources of the wind turbine, the CHP unit and the photovoltaic generator set; cₚᵤₙ is a penalty coefficient for wind rejection and light rejection; e is an environmental benefit coefficient of renewable energy such as wind power and the photovoltaic;

$${H}_{int}^{t} , {H}_{shi}^{t} , {G}_{int}^{t} and {G}_{shi}^{t}$$

are participation power of the reducible load and the transferable load in heat and gas integrated demand response respectively, and c_{IDR} is a unit power compensation cost coefficient of the integrated demand response; and c_{EV} is unit power income of the integrated energy operator selling the electricity to the EV operator.

A static model of the gas network is represented as:

$${m}_{L , in}^{t} = {m}_{L , out}^{t} , ∀ L {ϵΩ}_{g}^{pipe}$$

$${m}_{L , in}^{t} \leq {m}_{L , max} , {m}_{L , out}^{t} \leq {m}_{L , max}$$

L is a pipeline number of the natural gas network;

$${Ω}_{g}^{pipe}$$

is a set of pipelines of the natural gas network; and m_{L,max} is an upper limit of a flow rate.

A balance constraint of integrated energy power is:

$${P}_{CHP}^{t} + {P}_{WTG}^{t} + {P}_{PV}^{t} + {P}_{dis}^{t} + {P}_{grid}^{t} = {P}_{c}^{t} + {P}_{P 2 G}^{t} + {P}_{EH}^{t} + {P}_{L}^{t , actual} + {P}_{EV}^{t}$$

$${H}_{dis}^{t} + {H}_{CHP - Load}^{t} + {H}_{EH}^{t} + {H}_{GB}^{t} = {H}_{L}^{t , actual}$$

$${G}_{grid}^{t} + {G}_{P 2 G}^{t} = {G}_{L}^{t , actual} + {G}_{GB}^{t} + {G}_{CHP}^{t}$$

$${P}_{L}^{t , actual}$$

represents a load of the power distribution network at the moment t after the IDR is considered.

$${H}_{L}^{t , actual}$$

is a thermal load at the moment t after the IDR is considered.

$${G}_{L}^{t , actual}$$

is a gas load of the natural gas network at the moment t after IDR is considered.

Electricity and gas purchase amount constraints are:

$${P}_{grid}^{t} \leq {P}_{grid , max}$$

$${G}_{grid}^{t} \leq {G}_{grid , max}$$

P_{grid,max} and G_{grid,max} are upper limits of electricity and gas purchased from the superior power grid or the natural gas network respectively.

To sum up, the method for constructing an optimal scheduling model of an IES considering virtual thermal storage according to the disclosure constructs the optimal scheduling model of the IES considering the virtual thermal storage by establishing the operation models of the power distribution network, the heat supply network and the gas network and the operation mathematical model of each apparatus, considering the power flow constraint conditions of the power distribution network, the heat supply network and the gas network of the IES on this basis and taking minimization of the total operation cost of an integrated energy operator as the objective function, so as to obtain an optimal scheduling strategy.

### Example 2

An example of the disclosure is provided. A system for constructing an optimal scheduling model of an integrated energy system considering virtual thermal storage is provided. The system includes: a model establishment module, configured to establish an operation model of a working apparatus of the integrated energy system, establish an integrated demand response model of an integrated energy load and an orderly charging model of an EV, and establish an energy flow calculation model of a heat supply network considering the virtual thermal storage; a power flow processing module, configured to process, based on a mathematical theory, a direct current power flow model of a power distribution network, and transform a general power flow constraint into a mixed integer quadratic constraint programming constraint according to a second-order cone relaxation method; and an optimal scheduling module, configured to construct, according to power flow constraints of the power distribution network, the heat supply network and a gas network of the integrated energy system, the optimal scheduling model of the integrated energy system considering the virtual thermal storage by taking minimization of total operation cost of an integrated energy operator as an objective function.

### Example 3

An example of the disclosure is provided. The example differs from the above example in that:
if the functions are implemented in the form of software function modules and sold or used as independent products, the functions may be stored in a computer-readable storage medium. Based on such understanding, the technical solution of the disclosure, in essence or from the view of part contributing to the prior art or part of the technical solution, may be embodied in the form of a software product. The computer software product is stored into the storage medium and includes several instructions configured to make one computer device (which may be a personal computer, a server, or a network device) execute all or part of steps of the method of each of the examples of the disclosure. The above storage medium includes: a USB flash disk, a mobile hard disk, a read-only memory (ROM), a random access memory (RAM), a magnetic disk, an optical disk and other media capable of storing program codes.

Logic and/or steps represented in the flow diagram or described in other ways herein, for example, may be considered as a sequential list of executable instructions configured to implement logical functions, and may be specifically implemented in any computer-readable medium for use by an instruction execution system, apparatus, or device (such as a computer-based system, a system including a processor, or other systems that may obtain instructions from the instruction execution system, device, or apparatus and execute the instructions), or used in combination with the instruction execution system, device, or apparatus. For the purpose of the description, “computer-readable medium” may be any apparatus that may include, store, communicate with, propagate, or transmit programs for use by the instruction execution system, apparatus, or device, or in combination with the instruction execution system, apparatus, or device.

More specific examples of the computer-readable medium may include an electrical connection (electronic apparatus) having one or more wires, a portable computer diskette (magnetic apparatus), an RAM, an ROM, an erasable programmable read-only memory (EPROM or flash memory), an optical fiber apparatus and a portable compact disc read-only memory (CD-ROM). In addition, the computer-readable medium may even be paper or other appropriate media on which the program may be printed, because the program may be obtained electronically, for example, by optically scanning the paper or other media, followed by editing, interpreting, or otherwise processing as necessary, and then stored into a computer memory.

It should be understood that various portions of the disclosure may be implemented through hardware, software, firmware, or a combination of the hardware, the software and the firmware. In the above example, a plurality of steps or methods may be implemented by software or firmware stored into the memory and executed by the appropriate instruction execution system. For example, if the plurality of steps or methods are implemented by the hardware, as in another embodiment, the plurality of steps or methods may be implemented by any one or a combination of the following technologies known in the art: discrete logic circuits of logic gates for achieving logic functions on data signals, application-specific integrated circuits having appropriate combinational logic gates, programmable gate arrays (PGA), field programmable gate arrays (FPGA), etc.

### Example 4

An example of the disclosure is provided. A method for constructing an optimal scheduling model of an integrated energy system considering virtual thermal storage is provided. Scientific demonstration is carried out by means of economic benefit calculation and a simulation experiment in order to verify the beneficial effects of the disclosure.

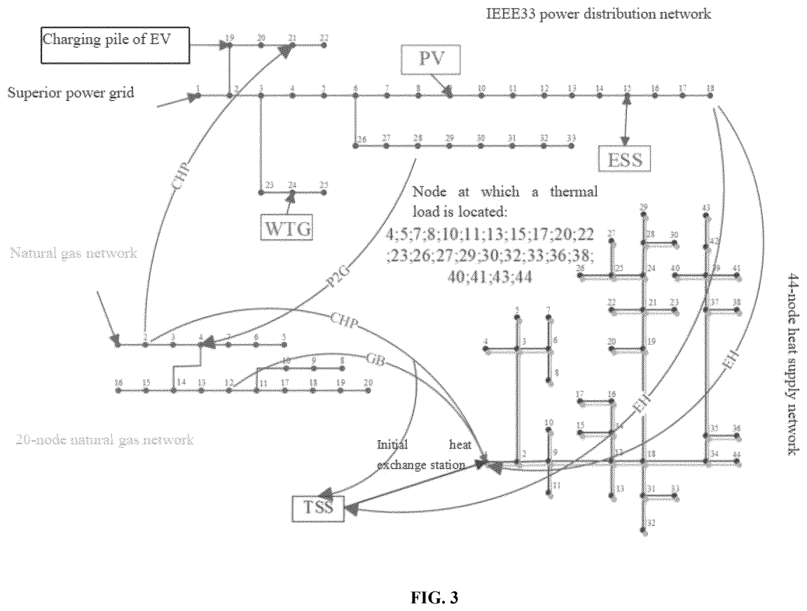

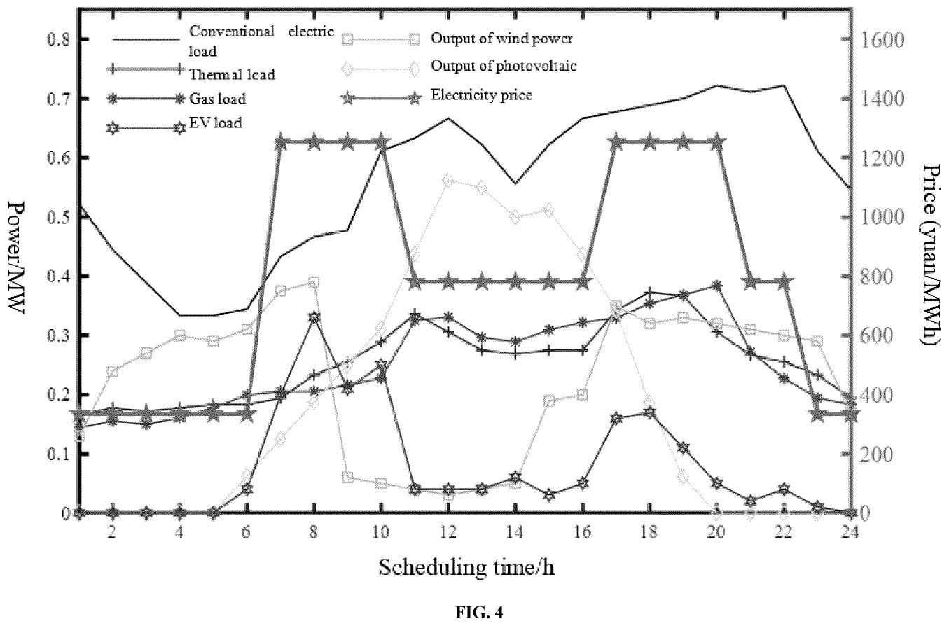

In order to verify effectiveness of the provided method for constructing an optimal scheduling model of an integrated energy system considering virtual thermal storage, an IEEE33-node power distribution network, a 20-node Belgian natural gas network and a 44-node heat supply network are tested by means of an urban IES shown in FIG. 3. Electric load, thermal load, gas load, photovoltaic and wind power curves and an electricity price curve under a typical operation scenario are shown in FIG. 4.

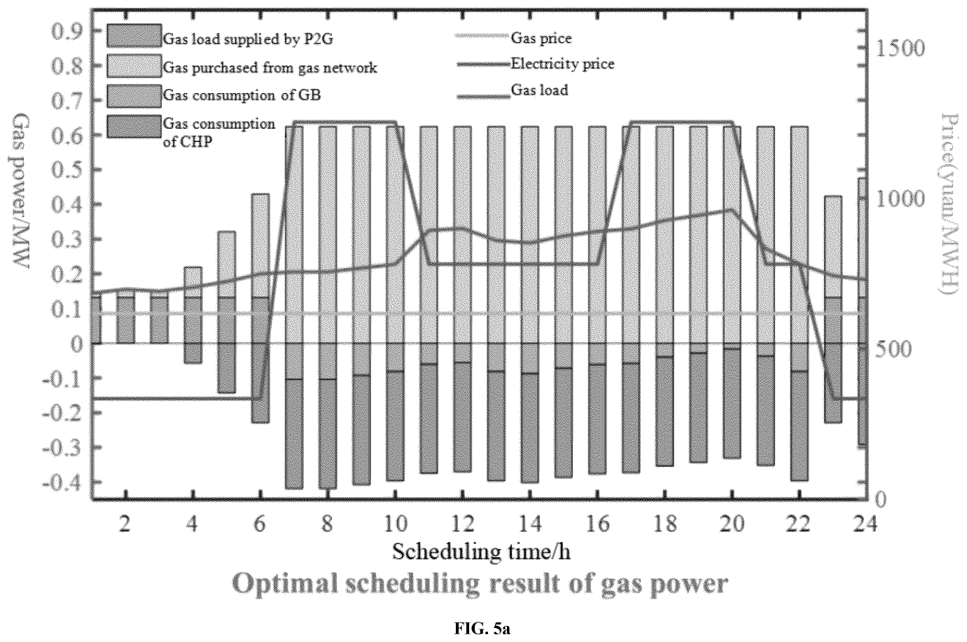

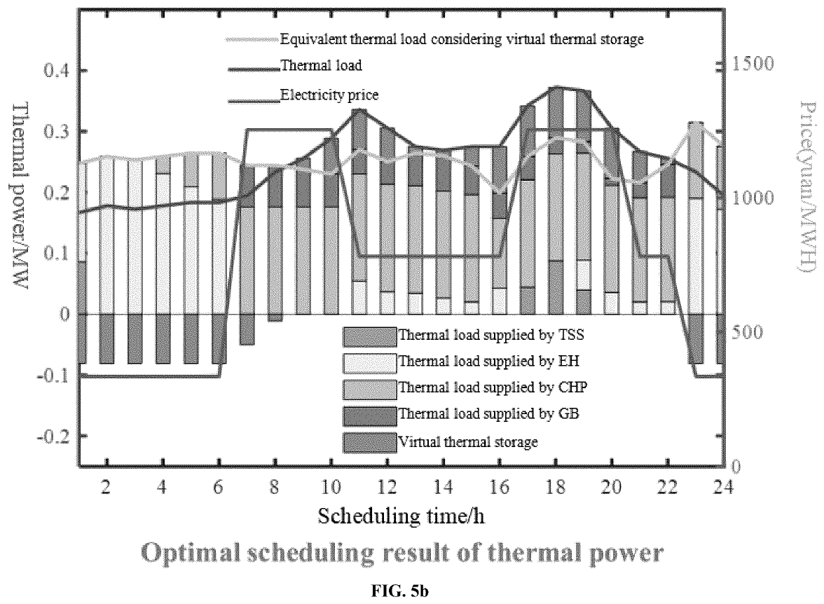

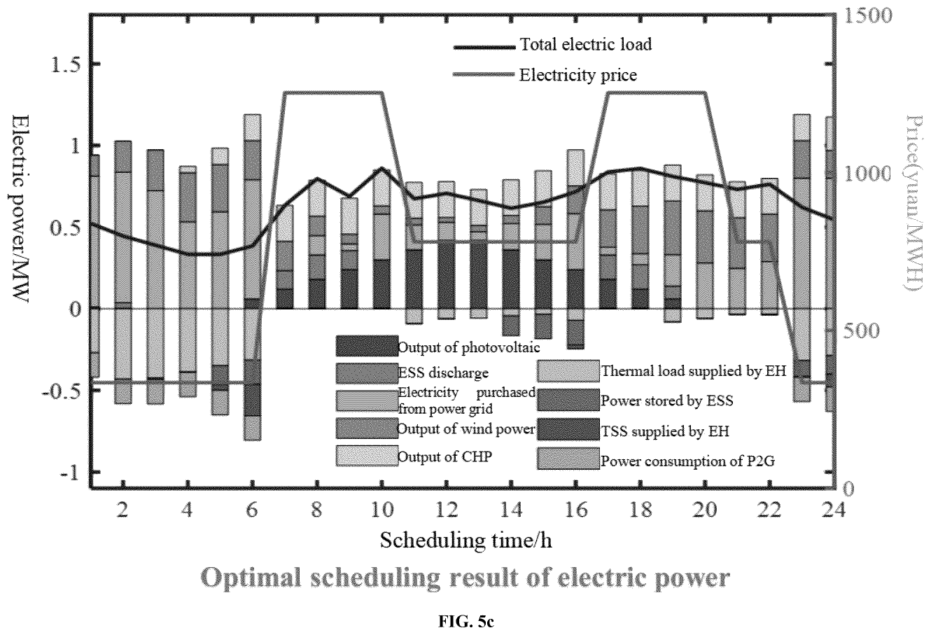

FIGS. 5a-5c shows an optimal scheduling result of an IES. Table 1 shows various input parameter values of resources, and Table 2 shows various cost results of an urban IES.

TABLE 1
Model-related constant parameters

| Parameter | Value | Parameter | Value |
|---|---|---|---|
| N_{EV} | 100 EVs | c_{WTG} | 200 yuan/MW |
| c_{TSS} | 50 yuan/MW | c_{CHP} | 55 yuan/MW |
| c_{E} | Time-of-use | c_{PV} | 60 yuan/MW |
| | electricity price | | |
| c_{G} | 660 yuan/MW | cₚᵤₙ | 800 yuan/MW |
| c_{EH} | 18 yuan/MW | e | 230 yuan/MW |
| c_{P2G} | 66 yuan/MW | c_{IDR} | −1000 yuan/MW |
| c_{GB} | 21 yuan/MW | c_{EV} | A value is the same |
| | | | as that of time-of- |
| | | | use electricity price |
| ${C}_{EVSOC}^{out , k}$ | 0.8 | ${η}_{CHP}^{E - H}$ | 0.8 |
| γ | 0.001 | ${η}_{CHP}^{H - G}$ | 0.56 |
| H_{GB,max} | 0.24 MW | P_{CHP,max} | 0.22 MW |
| ${P}_{CHP}^{climb , max}$ | 0.06 MW/h | η_{GB} | 0.66 |
| P_{PV,dimb} | 0.06 MW/h | P_{WTG,dimb} | 0.06 MW/h |
| η_{EH} | 0.6 | P_{EH,max} | 1 MW |
| η_{P2G} | 0.88 | P_{P2G,max} | 0.15 MW |
| P_{c,max} | 0.15 | P_{dis,max} | 0.15 |
| λ | 0.95 | C_{SOC,max} | 0.45 MWh |
| C_{SOC,min} | 0.05 MWh | β | 0.006 |
| C_{TSS,max} | 1.3 MWh | C_{TSS,min} | 1.1 MWh |
| H_{c,max} | 0.167 MW | H_{dis,max} | 0.167 MW |
| ${C}_{TSS}^{0}$ | 0.25 MWh | ${γ}_{IDR}^{int}$ | 0.0009 |
| ${P}_{IDR}^{shi , max}$ | Minimum value corresponding to a | ${γ}_{IDR}^{cha}$ | 0.0009 |
| | node load at all | | |
| | moments | | |
| ${η}_{IDR}^{E - H}$ | 0.55 | ${η}_{IDR}^{E - G}$ | 0.35 |
| ${C}_{EVSOC}^{in , k}$ | 0/0.3/0.5 | P_{k,t} | 0.01 MW |
| P_{line,max} | 5 MW | I_{line,max} | \sqrt{3}kA |
| ${T}_{in}^{initial , S} , {T}_{in}^{initial , R}$ | 55° C. | ${T}_{max}^{S} , {T}_{max}^{R}$ | 100° C. |
| ${T}_{min}^{S} , {T}_{min}^{R}$ | 10º C. | ${k}_{p}^{S}$ | 2 W/(m · ° C.) |
| ${T}_{env}^{t}$ | 1° C. | ${S}_{p}^{S}$ | A value is provided by related examples |
| | | | of international |
| | | | standards |
| ${l}_{p}^{S}$ | A value is provided by | H_{PES,max} | 0.0804 |
| | related examples | | |
| | of international | | |
| | standards | | |
| H_{PES,min} | 0 | c_{cha,IDR} | 15 yuan/MW |
| m_{L,max} | 100 m³/h | P_{grid,max} | 0.8 MW |
| G_{grid,max} | 0.624 MW | Network related | A value is provided |
| | | parameter | by related examples |
| | | | of international |
| | | | standards |
| Eₖ | 0.03 MWh | On and off-grid | A value is given by |
| | | time of EV | an EV operator |

TABLE 2
Various operation cost

| | |
|---|---|
| Total costf | 11184.4 yuan |
| Operation and maintenance cost f_{MIESD} | 59.8596 yuan |
| of multi-type energy storage apparatus | |
| (which includes cost of an ESS operator) | |
| Electricity and gas purchase expenses f_{buy} | 11867 yuan |
| Operation cost f_{ECD} of energy conversion | 390.6606 yuan |
| apparatus | |
| Operation and maintenance cost f_{DG} of | 1085.6 yuan |
| distributed power generation | |
| Penalty cost fₚᵤₙ of wind rejection and | 1680.8 yuan |
| light rejection | |
| Environmental benefit income fₑₙᵥ of | 1789.4 yuan |
| renewable energy | |
| Compensation cost f_{IDR} of IDR | 10.8372 yuan |
| Profit f_{EV} obtained by an integrated | 2121.1 yuan |
| energy operator selling electricity to an | |
| EV operator | |

An electric power system may satisfy an electric load demand in the system, and a difference between the sum (including equivalent “negative power” converted by an apparatus) of outputs of apparatuses at each moment and a current load is caused by a demand response. At 1:00-6:00, an electricity price is at a valley price, and is 335 yuan/MWh, an electric load demand is small, and required power is less than 0.5 MW. In this case, an output of wind power is large at night, and is about 0.3 MW. Thus, a large amount of electricity may be purchased from a superior power grid, and moreover, redundant electric power is brought. The redundant electric power may be transferred or consumed by means of a P2G, an EH and an ESS, and an amount of transferred electric power is approximately 0.5 MW. Thus, an amount of rejected wind may be reduced, and moreover, operation cost of an operator may be reduced. At 7:00-11:00, the electricity price is at a peak, and reaches 1250 yuan/MWh, and a total demand for the electric load is high, and exceeds 0.7 MW after loads generated by EVs are superimposed. A peak price limits an amount of electricity purchased from the superior power grid during scheduling, and electricity purchase power is lower than 0.1 MW. During this period of time, the ESS releases the electric power to satisfy real-time balance of the electric power, and the demand response generates an effect (about 0.01 MW), and effectively weakens an actual electric power demand. Thus, the ESS often purchases more electricity from the superior power grid at the valley price, stores the redundant electricity, and releases the electric power at the peak price. After 7:00, the output of a CHP is relatively constant, and basically reaches an upper limit of an output of the electric power of 0.22 MW, since an electric load, a thermal load and a gas load are high at this period of time. The CHP may enter an output mode of “power determined by heat” or “heat determined by power” to convert gas power into electric power and thermal power simultaneously according to a certain proportion coefficient. Compared with certain penalty cost and gas purchase cost of wind and light rejection, inclusion in the CHP may become more economical from a perspective of global scheduling, thereby reducing operation cost. At 11:00-16:00, a photovoltaic output is extremely large, and reaches about 0.5 MW. The electricity price is at parity of 780 yuan/MWh, an amount of electricity purchased from the superior power grid is moderate (0.1 MW-0.3 MW), and only a small amount of electric power is stored by means of the ESS or converted by means of the EH (less than 0.2 MW). At 16:00-20:00, according to an orderly charging behavior of an EV, a total electric load during this period of time is relatively high after the EV is considered. The electricity price returns to the peak price, and the amount of electricity purchased from the superior power grid is limited anew (less than 0.2 MW). The ESS continues to release a small amount of electric power (less than 0.1 MW), such that the electric power is kept in balance. In this case, almost no electric power is converted and stored. At 22:00-24:00, the electricity price returns to the valley price, and the amount of electricity purchased from the power grid is increased anew, and reaches the upper limit of 0.8 MW. The redundant electric energy is stored by means of the ESS, converted into heat energy by means of the EH, or converted into the gas power by means of the P2G. The part of electric power exceeds 0.5 MW, thereby well maintaining economic efficiency of scheduling of the IES.

The heat supply network may satisfy the thermal load demand in the system, and a difference between the sum (including equivalent “negative power” converted by an apparatus) of outputs of apparatuses at each moment and a current load is caused by a demand response and the virtual thermal storage of the heat supply network. By comparing an actual thermal load curve with an equivalent thermal load curve considering the virtual thermal storage, it may be seen that virtual thermal storage characteristics of the heat supply network adjust an original actual thermal load much more gently. A peak value of the thermal load is adjusted from 0.372 MW to 0.315 MW, and a valley value is adjusted from 0.167 MW to 0.203 MW, thereby really having an effect of “peak cutting and valley filling” of the thermal load. Since the virtual thermal storage characteristics of pipelines have an extremely significant effect, physical thermal storage TSS participates in the scheduling effect obviously (0.05 MW-0.1 MW) only when the thermal load is extremely high, i.e. 17:00-19:00 (exceeding 0.3 MW). During this period of time, the TSS releases the thermal power to have an auxiliary effect in adjustment of the virtual thermal storage. Thermal storage of the TSS mainly comes from conversion of the EH, and is generally carried out during the redundancy period of time of the electric power described above. Specifically, at 1:00-6:00 and 22:00-24:00 when the electricity price is the valley price, since the cost of electricity purchase from the superior power grid is small, the operator may select to purchase a large amount of electric power from the power grid. In this case, the electric power is redundant, the EH heavily participates in supplying the thermal load, and the CHP participates in supplying the thermal load to some extent. Thus, the thermal load generates redundancy. The redundant thermal power is stored into the pipeline in a form of a pipeline temperature or a temperature difference, i.e. virtual thermal storage power. At 7:00-21:00, the thermal load is relatively high. In this case, the electricity price is at the parity or the peak price as a whole, conversion of the EH is relatively small, and the thermal power born by the CHP unit exceeds 70%. Since the gas price of 660 yuan/MWh is between the parity and the valley price of the electricity price, the most economical scheduling strategy during this period of time is that the operator purchases much gas power from the natural gas network, and moreover, the gas power is converted. Thus, the GB works at this period of time to convert the gas power into the thermal power, and converted power does not exceed 0.1 MW. An equivalent effect of the virtual thermal storage at 7:00-21:00 is to release the thermal storage power in remaining periods of time to satisfy the high demand of the thermal load during this period of time.

The natural gas network may satisfy the gas load demand in the system, and a difference between the sum (including equivalent “negative power” converted by an apparatus) of outputs of apparatuses at each moment and a current load is caused by a demand response. At 1:00-6:00 and 22:00-24:00, the electricity price is lower than the gas price, and the operator of the power distribution network selects to purchase a large amount of electric power from the superior power grid. Part of the electric power is converted into gas power by means of the P2G apparatus to supply the gas load, and conversion of the gas power reaches a maximum limit of 0.15 MW. At 7:00-21:00, since the gas price is lower than the electricity price, the integrated energy operator may select to purchase enough natural gas (up to a maximum gas power limit of 0.624 MW) to completely supply the gas load. Redundant natural gas becomes a raw material for the CHP unit, or is converted into thermal power by means of the GB. Conversion power ranges from 0.3 MW to 0.4 MW, so as to achieve economic efficiency of scheduling of the IES.

It should be noted that the above examples are merely intended for description of the technical solutions of the disclosure rather than limitation of the disclosure. Although the disclosure is described in detail with reference to the preferred examples, those of ordinary skill in the art should understand that they can make modifications or equivalent replacements to the technical solutions of the disclosure without departing from the spirit and scope of the technical solutions of the disclosure, all of which should fall within the scope of the claims of the disclosure.

What is claimed is:

1. A method for constructing an optimal scheduling model of an integrated energy system considering virtual thermal storage, comprising:
establishing an operation model of a working apparatus of the integrated energy system, establishing an integrated demand response model of an integrated energy load and an orderly charging model of an electric vehicle (EV), and establishing an energy flow calculation model of a heat supply network considering the virtual thermal storage;
processing, based on a mathematical theory, a direct current power flow model of a power distribution network, and transforming a general power flow constraint into a mixed integer quadratic constraint programming constraint according to a second-order cone relaxation method; and
constructing, according to power flow constraints of the power distribution network, the heat supply network and a gas network of the integrated energy system, the optimal scheduling model of the integrated energy system considering the virtual thermal storage by taking minimization of total operation cost of an integrated energy operator as an objective function.

2. The method for constructing an optimal scheduling model of an integrated energy system considering virtual thermal storage according to claim 1, wherein the operation model of the working apparatus of the integrated energy system comprises a wind turbine model, a photovoltaic generator set model, a combined heat and power unit model, a gas boiler (GB) model, an electric heater (EH) model, a power to gas (P2G) apparatus model, an energy storage system model, and a thermal storage system model, wherein
the wind turbine model is represented by the following formulas:
$$P = \frac{1}{2} ρ {Sv}^{3} ;$$
$${η}_{max} = \frac{{P}_{max}}{P} = 0.593 ;$$
$$P = \frac{1}{2} {η}_{w} ρ {Sv}^{3} ;$$
$${P}_{WTG} ( v ) = \{ \begin{matrix}0 ( v \leq {v}_{ci} , v \geq {v}_{co} ) \\ \frac{{v}^{3} - {v}_{ci}^{3}}{{v}_{r}^{3} - {v}_{ci}^{3}} {P}_{r} ( {v}_{ci} \leq v \leq {v}_{r} ) \\ {P}_{r} ( {v}_{r} \leq v \leq {v}_{co} )\end{matrix} ;$$
$${P}_{WTGtotal}^{t} = {P}_{WTG}^{t} + {P}_{WTGwaste}^{t} ; and$$
$$\vert {P}_{WTG}^{t} - {P}_{WTG}^{t - 1} \vert \leq {P}_{WTG , climb} ,$$
wherein
v is a wind speed of a wind turbine, S represents a swept area, and ρ is an air density; ηₘₐₓ is a maximum utilization rate of wind energy, and Pₘₐₓ is maximum output power; η_{w} is a utilization rate of the wind energy; Pᵣ and P_{WTG}(v) are rated power and actual power of the wind turbine respectively, v and vᵣ are an actual wind speed and a rated wind speed of the wind turbine respectively, and v_{ci} and v_{co} are an inflow wind speed and an outflow wind speed of the wind turbine respectively;
$${P}_{PVtotal}^{t}$$
is total output power,
$${P}_{PV}^{t}$$
is actual output power, and
$${P}_{PVwaste}^{t}$$
is light rejection power; and P_{TWG,climb} is an upper limit of a climbing constraint;
the photovoltaic generator set model is represented by the following formulas:
$${P}_{PVtotal}^{t} = {P}_{PV}^{t} + {P}_{PVwaste}^{t} ; and$$
$$\vert {P}_{PV}^{t} - {P}_{PV}^{t - 1} \vert \leq {P}_{PV , climb} ,$$
wherein
$${P}_{PVtotal}^{t}$$
is total output power of a photovoltaic,
$${P}_{PV}^{t}$$
is actual output power, and
$${P}_{PVwaste}^{t}$$
is light rejection power; and P_{PV,climb} is an upper limit of a climbing constraint of the photovoltaic;
the combined heat and power unit model is represented by the following formulas:
$${P}_{CHP}^{t} = {η}_{CHP}^{E - H} {H}_{CHP}^{t} = {η}_{CHP}^{E - H} ( {η}_{CHP}^{H - G} {G}_{CHP}^{t} ) ;$$
$${P}_{CHP , min} \leq {P}_{CHP}^{t} \leq {P}_{CHP , max} ;$$
$$\vert {P}_{CHP}^{t} - {P}_{CHP}^{t - 1} \vert \leq {P}_{CHP}^{climb , max} ; and$$
$${H}_{CHP}^{t} = {H}_{CHP - TSS}^{t} + {H}_{CHP - Load}^{t} ,$$
wherein
$${P}_{CHP}^{t}$$
is electric power generated by a combined heat and power unit,
$${H}_{CHP}^{t}$$
is thermal power generated by the combined heat and power unit,
$${G}_{CHP}^{t}$$
is gas power consumed by the combined heat and power unit,
$${η}_{CHP}^{E - H}$$
is an electricity-heat proportion coefficient, and
$${η}_{CHP}^{H - G}$$
is a gas-heat conversion coefficient; P_{CHP,min} and P_{CHP,max} represent a lower limit and an upper limit of an output of the electric power of the combined heat and power unit respectively;
$${P}_{CHP}^{climb , max}$$
represents an upper limit of a climbing rate of the electric power of the combined heat and power unit; and
$${H}_{CHP}^{t}$$
is total heat output power of the combined heat and power unit,
$${H}_{CHP - Load}^{t}$$
is power at which a thermal load is supplied, and
$${H}_{CHP - TSS}^{t}$$
is power at which the thermal load is stored into a thermal storage system;
the GB model is represented by the following formulas:
$${H}_{GB}^{t} = {η}_{GB} {G}_{GB}^{t} ; and$$
$${H}_{GB , min} \leq {H}_{GB}^{t} \leq {H}_{GB , max} ,$$
wherein
$${H}_{GB}^{t}$$
is thermal power generated by a GB,
$${G}_{G B}^{t}$$
is gas power consumed by the GB, and η_{GB} is a gas-heat conversion coefficient of the GB; and H_{GB,min} and H_{GB,max} represent a lower limit and an upper limit of an output of the thermal power of the GB;
the EH model is represented by the following formulas:
$${H}_{EH}^{t} = {η}_{EH} {P}_{EH}^{t} ; and$$
$${P}_{EH , min} \leq {P}_{EH}^{t} \leq {P}_{EH , max} ,$$
wherein
$${H}_{EH}^{t}$$
is thermal power generated by an EH,
$${P}_{EH}^{t}$$
is electric power consumed by the EH, and η_{EH} is an electricity-heat conversion coefficient of the EH; and P_{EH,min} and P_{EH,max} represent a lower limit and an upper limit of the electric power consumed by the EH respectively;
the P2G apparatus model is represented by the following formulas:
$${G}_{P 2 G}^{t} = {η}_{P 2 G} {P}_{P 2 G}^{t} ; and$$
$${P}_{P 2 G , min} \leq {P}_{P 2 G}^{t} \leq {P}_{P 2 G , max}$$
wherein
$${G}_{P 2 G}^{t}$$
is gas power generated by P2G,
$${P}_{P 2 G}^{t}$$
is electric power consumed by the P2G, and η_{P2G} is an electricity-gas conversion coefficient of the EH; and P_{P2G,min} and P_{P2G,max} represent a lower limit and an upper limit of the electric power consumed by the P2G respectively;
the energy storage system model is represented by the following formulas:
$${C}_{SOC}^{t} = ( 1 - γ ) {C}_{SOC}^{t - 1} + λ {P}_{c}^{t} Δ t - \frac{{P}_{dis}^{t}}{λ} Δ t ;$$
$${P}_{c}^{t} {P}_{dis}^{t} = 0 ;$$
$${C}_{SOC}^{0} = {C}_{SOC}^{T} ;$$
$${C}_{SOC , min} \leq {C}_{SOC}^{t} \leq {C}_{SOC , max} ;$$
$${P}_{c}^{t} \leq {P}_{c , max} ; and$$
$${P}_{dis}^{t} \leq {P}_{dis , max} ,$$
wherein
$${C}_{SOC}^{t} and {C}_{SOC}^{t - 1}$$
represent states of charges (SOCs) of a battery at a moment t and a moment t−1 respectively,
$${P}_{c}^{t} and {P}_{dis}^{t}$$
represent charge power and discharge power at the moment t respectively, γ is an electric energy dissipation coefficient of the energy storage system, λ is a charge and discharge efficiency coefficient of the battery, and Δt is unit scheduling time; and T represents a scheduling period,
$${C}_{SOC}^{0} and {C}_{SOC}^{T}$$
represent SOCs of the energy storage system at a beginning and an end of the scheduling period respectively, c_{SOC,min} and c_{SOC,max} represent a lower limit and an upper limit of the SOC of the energy storage system, P_{c,max} is an upper limit of the charge power of the energy storage system, and P_{dis,max} is an upper limit of the discharge power of the energy storage system; and
the thermal storage system model is represented by the following formulas:
$${C}_{TSS}^{t} = ( 1 - β ) {C}_{TSS}^{t - 1} + {H}_{c}^{t} Δ t - {H}_{dis}^{t} Δ t ;$$
$${H}_{c}^{t} {H}_{dis}^{t} = 0 ;$$
$${C}_{TSS}^{0} = {C}_{TSS}^{T} ;$$
$${C}_{TSS , min} \leq {C}_{TSS}^{t} \leq {C}_{TSS , max} ;$$
$${H}_{c}^{t} \leq {H}_{c , max} ; and$$
$${H}_{dis}^{t} \leq {H}_{dis , max} ,$$
wherein
$${C}_{TSS}^{t} and {C}_{TSS}^{t - 1}$$
represent thermal storage amounts of the thermal storage system at the moment t and the moment t−1 respectively,
$${H}_{c}^{t} and {H}_{dis}^{t}$$
represent thermal storage power and thermal release power of the thermal storage system at the moment t respectively, and β is a dissipation coefficient of the thermal storage system; and
$${C}_{TSS}^{0} and {C}_{TSS}^{T}$$
represent thermal storage amounts of the thermal storage system at the beginning and the end of the scheduling period respectively, c_{TSS,min} and c_{TSS,max} represent a lower limit and an upper limit of the thermal storage amount of the thermal storage system, H_{c,max} is an upper limit of the thermal storage power of the thermal storage system, and H_{dis,max} is an upper limit of the thermal release power of the thermal storage system.

3. The method for constructing an optimal scheduling model of an integrated energy system considering virtual thermal storage according to claim 2, wherein the integrated demand response model of the integrated energy load is represented by the following formulas:
$${P}_{IDR}^{t} = {P}_{IDR}^{t , int} + {P}_{IDR}^{t , shi} + {P}_{IDR}^{t , cha} ;$$
$$0 \leq {P}_{IDR}^{t , int} \leq {γ}_{IDR}^{int} {P}_{L}^{t} ;$$
$${P}_{IDR}^{t , shi} = {P}_{IDRout}^{t , shi} - {P}_{IDRin}^{t , shi} ;$$
$${P}_{IDRout}^{t , shi} {P}_{IDRin}^{t , shi} = 0 ;$$
$${\sum }_{t = 1}^{T} {P}_{IDRout}^{t , shi} = {\sum }_{t = 1}^{T} {P}_{IDRin}^{t , shi} ;$$
$$0 \leq {P}_{IDR}^{t , shi} \leq {P}_{IDR}^{shi , max} ;$$
$$0 \leq {P}_{IDR}^{t , cha} \leq {γ}_{IDR}^{cha} {P}_{L}^{t} ;$$
$${P}_{L}^{t , actual} = {P}_{L}^{t} - {P}_{IDR}^{t , int} - {P}_{IDR}^{t , shi} - {P}_{IDR}^{t , cha} ;$$
$${H}_{IDR}^{t , cha} = {η}_{IDR}^{E - H} {P}_{IDR}^{t , cha} ;$$
$${G}_{IDR}^{t , cha} = {η}_{IDR}^{E - G} {P}_{IDR}^{t , cha} ;$$
$${H}_{L}^{t , actual} = {H}_{L}^{t} - {H}_{IDR}^{t , int} - {H}_{IDR}^{t , shi} + {H}_{IDR}^{t , cha} ;$$
$${G}_{L}^{t , actual} = {G}_{L}^{t} - {G}_{IDR}^{t , int} - {G}_{IDR}^{t , shi} + {G}_{IDR}^{t , cha} ; and$$
$${η}_{IDR}^{E - H} + {η}_{IDR}^{E - G} \leq 1 ,$$
wherein
$${P}_{IDR}^{t , int} , {P}_{IDR}^{t , shi} and {P}_{IDR}^{t , cha}$$
represent a reducible load, a transferable load and a substitutional load respectively;
$${γ}_{IDR}^{int}$$
is a maximum participation proportion coefficient of the reducible load, and
$${P}_{L}^{t}$$
is a total electric load at the moment t;
$${P}_{IDR}^{shi , max}$$
is a maximum participation value of the transferable load;
$${γ}_{IDR}^{cha}$$
is a maximum participation proportion coefficient of the substitutional load;
$${H}_{IDR}^{t , cha}$$
is thermal load power converted from the substitutional load, and
$${η}_{IDR}^{E - H}$$
is an electricity-heat conversion coefficient of the substitutional load; and
$${G}_{IDR}^{t , cha}$$
is gas load power converted from the substitutional load, and
$${η}_{IDR}^{E - G}$$
is an electricity-gas conversion coefficient; and
the orderly charging model of the EV is represented by the following formulas:
$$( {C}_{EVSOC}^{out , k} - {C}_{EVSOC}^{in , k} ) {E}_{k} \leq {W}_{EV}^{k} \leq ( 1 - {C}_{EVSOC}^{in , k} ) {E}_{k} ;$$
$$( {C}_{EVSOC}^{t , k} - {C}_{EVSOC}^{t - 1 , k} ) {E}_{k} = {α}_{k , t} {p}_{k , t} Δ t ;$$
$${W}_{EV}^{k} = {\sum }_{t = 1}^{Tk} {α}_{k , t} {p}_{k , t} Δ t ; and$$
$${P}_{EV}^{t} = {\sum }_{k = 1}^{{N}_{EV}} {α}_{k , t} {p}_{k , t} Δ t ,$$
wherein
k is a number of the EV,
$${C}_{EVSOC}^{out , k}$$
represents a percentage of a minimum off-grid SOC specified by an EV user having the number of k in battery capacity,
$${C}_{EVSOC}^{in , k}$$
represents a percentage of an on-grid SOC of the EV in the battery capacity, Eₖ is the battery capacity, and
$${W}_{EV}^{k}$$
is a total charge demand of the user;
$${C}_{EVSOC}^{t , k} and {C}_{EVSOC}^{t - 1 , k}$$
are SOCs of the vehicle k in a period of time t and a period of time t−1 respectively; p_{k,t} is average charge and discharge power of the EV in a fast charge mode; α_{k,t} is a 01 variable representing charging or occupation, i.e. an identifier, is valued as 0 or 1, and represents that the vehicle is in an occupied state and a charge state respectively; Tₖ represents the total number of periods of time during which the vehicle k is accessed to a power grid; and N_{EV} represents the number of EVs.

4. The method for constructing an optimal scheduling model of an integrated energy system considering virtual thermal storage according to claim 3, wherein the energy flow calculation model of the heat supply network considering the virtual thermal storage comprises:
a power exchange model of an initial heat exchange station and a heat exchange station being as follows:
$$( {H}_{CHP}^{t} + {H}_{EH - Load}^{t} + {H}_{dis}^{t} + {H}_{GB}^{t} ) Δ t = {c}_{w} {m}_{HS}^{t} ( {T}_{HS , in}^{t , S} - {T}_{HS , out}^{t , R} ) ; and$$
$${c}_{w} {m}_{HES}^{t} ( {T}_{HESout}^{t , S} - {T}_{HESin}^{t , R} ) = {H}_{L}^{t} Δ t ,$$
wherein
$${T}_{HS , in}^{t , S} and {T}_{HS , out}^{t , R}$$
are an inlet temperature in a water supply pipeline and an outlet temperature in a water return pipeline connected to the initial heat exchange station respectively;
$${m}_{HS}^{t}$$
is a flow rate of water flowing through the initial heat exchange station; c_{w} is specific heat capacity of the water;
$${T}_{HESout}^{t , S} and {T}_{HESin}^{t , R}$$
are an outlet temperature in the water supply pipeline and an inlet temperature in the water return pipeline connected to the heat exchange station respectively;
$${m}_{HES}^{t}$$
is a flow rate of hot water flowing through the heat exchange station; and
$${H}_{L}^{t}$$
is a thermal load at the moment t;
a temperature mixing constraint and a range constraint being as follows:
$${\sum }_{j {ϵΩ}_{h , n}^{pipe -}} {T}_{j , out}^{t} {q}_{j} = {T}_{k , in}^{t} {\sum }_{k {ϵΩ}_{h , n}^{pipe +}} {q}_{k} ;$$
$${T}_{min}^{S} \leq {T}_{p}^{t , S} \leq {T}_{max}^{S} , ∀ p {ϵΩ}_{h}^{pipe} ; and$$
$${T}_{min}^{R} \leq {T}_{p}^{t , R} \leq {T}_{max}^{R} , ∀ p {ϵΩ}_{h}^{pipe} ,$$
wherein
$${Ω}_{h , n}^{pipe +} and {Ω}_{h , n}^{pipe -}$$
and represent pipeline sets starting from and ending at a node n in the heat supply network respectively;
$${T}_{k , in}^{t}$$
is an inlet temperature of a water supply pipeline k at the moment t; qₖ and qⱼ are flow rates of water supply pipelines k and j respectively, which are kept constant;
$${T}_{j , out}^{t}$$
is an outlet temperature of the water supply pipeline j at the moment t^{t};
$${T}_{max}^{S} and {T}_{min}^{S}$$
are an upper limit and a lower limit of a temperature of the water supply pipeline respectively; and
$${T}_{max}^{R} and {T}_{min}^{R}$$
are an upper limit and a lower limit of a temperature of the water return pipeline respectively;
according to a node method, the heat supply network considering transmission delay and temperature loss being modeled as follows:
$${τ}_{p}^{S} = \frac{{l}_{p}^{S} {S}_{p}^{S} {ρ}_{w}}{{q}_{p}^{S} Δ t} ;$$
$$K = ⌈ {τ}_{p}^{S} ⌉ ;$$
$${τ}_{p}^{K - 1 , S} = ( K - 1 ) Δ t ;$$
$${τ}_{p}^{K , S} = K Δ t ;$$
$${T}_{p , out}^{t , K , S} = {e}^{- {k}_{p}^{S} {1}_{p}^{S} / {q}_{p}^{S} {c}_{w}} ( {T}_{p , in}^{t - ( K - 1 ) , S} - {T}_{env}^{t} ) + {T}_{env}^{t} ;$$
$${T}_{p , out}^{t , S} = {W}_{1} {W}_{3} {T}_{p , in}^{t - ( K - 1 ) , S} + {W}_{2} {W}_{3} {T}_{p , in}^{t - K , S} + ( 1 - {W}_{1} {W}_{3} - {W}_{2} {W}_{3} ) {T}_{env}^{t} ;$$
$${W}_{1} = \frac{{q}_{p}^{S} ( {τ}_{p}^{K , S} - {τ}_{p}^{S} )}{[ {q}_{p}^{S} ( {τ}_{p}^{K , S} - {τ}_{p}^{S} ) + {q}_{p + 1}^{S} ( {τ}_{p}^{S} - {τ}_{p}^{K - 1 , S} ) ]} ;$$
$${W}_{2} = \frac{{q}_{p + 1}^{S} ( {τ}_{p}^{S} - {τ}_{p}^{K - 1 , S} )}{[ {q}_{p}^{S} ( {τ}_{p}^{K , S} - {τ}_{p}^{S} ) + {q}_{p + 1}^{S} ( {τ}_{p}^{S} - {τ}_{p}^{K - 1 , S} ) ]} ; and$$
$${W}_{3} = {e}^{- {k}_{p}^{S} {1}_{p}^{S} / {q}_{p}^{S} {c}_{w}} ,$$
wherein
a superscript S only represents the water supply pipeline, a subscript p only represents a pipeline p, and a physical meaning of each symbol is kept consistent with that of the above;
$${τ}_{p}^{S}$$
is a transmission delay time constant of a whole pipeline, and
$${l}_{p}^{S} and {S}_{p}^{S}$$
represent a length and a cross-sectional area of the water supply pipeline p respectively; ρ_{w} is a density of water;
$${T}_{p , in}^{t - ( K - 1 ) , S}$$
is an inlet temperature of hot water in the water supply pipeline p at a period of time t−(K−1);
$${k}_{p}^{S}$$
is a temperature loss coefficient of the pipeline p; and
$${T}_{env}^{t}$$
is an ambient temperature of a district heat supply network.

5. The method for constructing an optimal scheduling model of an integrated energy system considering virtual thermal storage according to claim 4, wherein the energy flow calculation model of the heat supply network considering the virtual thermal storage further comprises:
pipeline energy storage of the heat supply network being as follows:
$${H}_{PES}^{t} = {\sum }_{p , q {ϵΩ}_{h}^{pipe}} {c}_{w} [ {q}_{p}^{S} ( {T}_{p , out}^{t , S} - {T}_{p , in}^{t , S} ) + {q}_{q}^{R} ( {T}_{q , out}^{t , R} - {T}_{q , in}^{t , R} ) ] Δ t ,$$
wherein
$${H}_{PES}^{t}$$
represents the pipeline energy storage of the heat supply network; a superscript R only represents the water return pipeline of the heat supply network, and a physical meaning of each symbol is kept consistent with that of the above; and
$${Ω}_{h}^{pipe}$$
is any group of pipeline sets in the heat supply network; and
upper and lower limit constraints and periodic recovery constraints of the pipeline energy storage of the district heat supply network being as follows:
$${H}_{PES , min} \leq {H}_{PES}^{t} \leq {H}_{PES , max} , and$$
$${H}_{PES}^{0} = {H}_{PES}^{T} ,$$
wherein
H_{PES,max} and H_{PES,min} represent an upper limit and a lower limit of the pipeline energy storage of the heat supply network respectively; and
$${H}_{PES}^{0}$$
are
$${H}_{PES}^{T}$$
are the pipeline energy storage of the heat supply network at the beginning and the end of the scheduling period respectively.

6. The method for constructing an optimal scheduling model of an integrated energy system considering virtual thermal storage according to claim 5, wherein the direct current power flow model of the power distribution network is processed based on the mathematical theory, and the general power flow constraint is transformed into the mixed integer quadratic constraint programming constraint according to the second-order cone relaxation method:
$${\tilde{U}}_{j}^{t} = {\tilde{U}}_{i}^{t} - 2 {P}_{line , j}^{t} {R}_{line , j} + {I}_{line , j}^{t} {R}_{line , i}^{2} , ∀ l ( i , j ) ∈ {Ω}_{e}^{line} ;$$
$${\sum }_{a ∈ {Ω}_{n}^{+}} {P}_{line , a}^{t} - {\sum }_{b ∈ {Ω}_{n}^{-}} ( {P}_{line , b}^{t} - {\tilde{I}}_{line , b}^{t} {R}_{line , b} ) = {P}_{n , out}^{t} , ∀ n ∈ {Ω}_{e}^{node} ;$$
$${\tilde{I}}_{line , l}^{t} = {( {I}_{line , l}^{t} )}^{2} , ∀ l ( i , j ) ∈ {Ω}_{e}^{line} ;$$
$${\tilde{U}}_{n}^{t} = {( {U}_{n}^{t} )}^{2} , ∀ n ∈ {Ω}_{e}^{node} ;$$
$${‖ \begin{matrix}2 {P}_{line , l}^{t} \\ {\tilde{I}}_{line , l}^{t} - {\tilde{U}}_{l}^{t}\end{matrix} ‖}_{2} \leq {\tilde{I}}_{line , l}^{t} + {\tilde{U}}_{l}^{t} ∀ l ( i , j ) ∈ {Ω}_{e}^{line} ;$$
$$\vert {P}_{line , l}^{t} \vert \leq {P}_{line , max} , ∀ l ( i , j ) ∈ {Ω}_{e}^{line} ;$$
$$0 \leq {\tilde{I}}_{line , l}^{t} \leq {\tilde{I}}_{line , max}^{t} , ∀ l ( i , j ) ∈ {Ω}_{e}^{line} ; and$$
$$0 \leq {\tilde{U}}_{n}^{t} \leq {\tilde{U}}_{max}^{t} , ∀ n ∈ {Ω}_{e}^{node} ,$$
wherein
Iₗᵢₙₑ^{t} represents a branch current at the moment t, R_{line,1} and X_{line,1} represent a resistor and a reactor of a branch 1,
$${P}_{line}^{t} and {Q}_{line}^{t}$$
represent active power and reactive power flowing through the branch, and
$${U}_{i}^{t} and {U}_{j}^{t}$$
are voltages of nodes i and j at the moment t respectively;
$${Ω}_{e}^{line}$$
represents a set of all branches of the power distribution network;
$${Ω}_{e}^{node}$$
represents a set of all nodes of the power distribution network, and P_{n,out}^{t} and
$${Q}_{n , out}^{t}$$
are active power and reactive power of a net outflow node n; and P_{line,max} is maximum active power that the branch withstands, and Ĩ_{line,max} and Ũₘₐₓ are squares of maximum values allowable by a current and a voltage respectively.

7. The method for constructing an optimal scheduling model of an integrated energy system considering virtual thermal storage according to claim 6, wherein the objective function is as follows:
$$min f = {f}_{MTESD , TSS} + {f}_{buy} + {f}_{ECD} + {f}_{DG} + {f}_{pun} - {f}_{env} + {f}_{IDR} - {f}_{EV} ;$$
$${f}_{MTESD , TSS} = {\sum }_{t = 1}^{T} {c}_{TSS} ( \vert {H}_{c}^{t} \vert + \vert {H}_{dis}^{t} \vert ) Δ t ;$$
$${f}_{buy} = {\sum }_{t = 1}^{T} ( {c}_{E} {P}_{grid}^{t} + {c}_{G} {G}_{grid}^{t} ) Δ t ;$$
$${f}_{ECD} = {\sum }_{t = 1}^{T} ( {c}_{EH} {P}_{EH}^{t} + {c}_{P 2 G} {P}_{P 2 G}^{t} + {c}_{GB} {H}_{GB}^{t} ) Δ t ;$$
$${f}_{DG} = {\sum }_{t = 1}^{T} ( {c}_{WTG} {P}_{WTG}^{t} + {c}_{CHP} {P}_{CHP}^{t} + {c}_{PV} {P}_{PV}^{t} ) Δ t ;$$
$${f}_{pun} = {\sum }_{t = 1}^{T} ( {c}_{pun} {P}_{WTGwaste}^{t} + {c}_{pun} {P}_{PVwaste}^{t} ) Δ t ;$$
$${f}_{env} = {\sum }_{t = 1}^{T} ( {eP}_{PV}^{t} + {eP}_{WTG}^{t} ) Δ t ;$$
$${f}_{IDR} = {\sum }_{t = 1}^{T} {c}_{IDR} [ ( \vert {P}_{int}^{t} \vert + \vert {P}_{shi}^{t} \vert + \vert {H}_{int}^{t} \vert + \vert {H}_{shi}^{t} \vert + \vert {G}_{int}^{t} \vert + \vert {G}_{shi}^{t} \vert ) ] Δ t + {c}_{cha , IDR} ( 1 - {η}_{IDR}^{E - H} - {η}_{IDR}^{E - G} ) \vert {P}_{cha}^{t} \vert Δ t and$$
$${f}_{EV} = {\sum }_{t = 1}^{T} {c}_{EV} {P}_{EV}^{t} Δ t ,$$
wherein
f is total scheduling cost, f_{MTESD,TSS} is operation and maintenance cost of a physical thermal storage system in a multi-type energy storage apparatus, f_{buy} is electricity and gas purchase expenses, i.e. cost of electricity and gas purchased from a superior power grid and a natural gas network, f_{ECD} is operation cost of an energy conversion apparatus, f_{DG} is operation and maintenance cost of distributed power generation, fₚᵤₙ is penalty cost of wind rejection and light rejection, fₑₙᵥ is environmental benefit income of renewable energy, f_{IDR} is compensation cost of integrated demand response, and f_{EV} is profit obtained by the integrated energy operator selling electricity to an EV operator; c_{TSS} is unit power operation and maintenance cost of the thermal storage system;
$${P}_{grid}^{t}$$
is an amount of electricity purchased from the superior power grid, G_{grid}^{t} is an amount of gas purchased from the natural gas network, and c_{E} and c_{G} are unit electricity price and gas price respectively; c_{EH}, c_{P2G} and c_{GB} are unit power operation and maintenance cost of energy conversion apparatuses of (EH), the P2G and the GB respectively; c_{WTG}, c_{CHP} and c_{PV} are unit power operation and maintenance cost of distributed sources of the wind turbine, the combined heat and power unit and the photovoltaic generator set; cₚᵤₙ is a penalty coefficient for wind rejection and light rejection; e is an environmental benefit coefficient of renewable energy such as wind power and the photovoltaic;
$${H}_{int}^{t} , {H}_{shi}^{t} , {G}_{int}^{t} and {G}_{shi}^{t}$$
are participation power of the reducible load and the transferable load in heat and gas integrated demand response respectively, and c_{IDR} is a unit power compensation cost coefficient of the integrated demand response; and c_{EV} is unit power income of the integrated energy operator selling the electricity to the EV operator.

8. A system using the method for constructing an optimal scheduling model of an integrated energy system considering virtual thermal storage according to claim 1, comprising:
a model establishment module, configured to establish an operation model of a working apparatus of the integrated energy system, establish an integrated demand response model of an integrated energy load and an orderly charging model of an EV, and establish an energy flow calculation model of a heat supply network considering the virtual thermal storage;
a power flow processing module, configured to process, based on a mathematical theory, a direct current power flow model of a power distribution network, and transform a general power flow constraint into a mixed integer quadratic constraint programming constraint according to a second-order cone relaxation method; and
an optimal scheduling module, configured to construct, according to power flow constraints of the power distribution network, the heat supply network and a gas network of the integrated energy system, the optimal scheduling model of the integrated energy system considering the virtual thermal storage by taking minimization of total operation cost of an integrated energy operator as an objective function.

9. A computer device, comprising: a memory and a processor, wherein the memory stores a computer program, and the processor implements steps of the method for constructing an optimal scheduling model of an integrated energy system considering virtual thermal storage according to claim 1 when executing the computer program.

10. A computer-readable storage medium, storing a computer program, wherein the computer program implements steps of the method for constructing an optimal scheduling model of an integrated energy system considering virtual thermal storage according to claim 1 when executed by a processor.
